(19) United States
(12) Patent Application Publication
(10) Pub. No.: US 2025/0259535 A1
(43) Pub. Date: Aug. 14, 2025

(54) Car-On-Map (CAROM) Air Framework for Vehicle Localization and Traffic Scene Reconstruction Using Aerial Video

(71) Applicants: Duo Lu, Tempe, AZ (US); Yezhou Yang, Phoenix, AZ (US)

(72) Inventors: Duo LU, Tempe, AZ (US); Yezhou YANG, Phoenix, AZ (US)

(73) Assignee: Arizona Board of Regents on Behalf of Arizona State University, Scottsdale, AZ (US)

(21) Appl. No.: 18/657,638

(22) Filed: May 7, 2024

Related U.S. Application Data
(60) Provisional application No. 63/500,720, filed on May 8, 2023.

(51) Int. Cl. G08G 1/01; G06T 7/33; G06V 10/82; G06V 20/17; G06V 20/54; G08G 1/04

(52) U.S. Cl. CPC G08G 1/0125; G06T 7/337; G06V 10/82; G06V 20/17; G06V 20/54; G08G 1/04; G06T 2207/30236; G06V 2201/08

(57) ABSTRACT

Processing circuitry may configure a system to implement a CAR-OnMap (“CAROM”) air framework for vehicle localization and traffic scene reconstruction using the aerial video of the traffic scene. Such a system may obtain aerial video of a traffic scene including vehicles that traverse the traffic scene and a satellite map image of the traffic scene as a distinct reference image. In such an example, processing circuitry may determine aerial image reference points within the aerial image which correspond to reference points in the satellite map image of the traffic scene. Processing circuitry may responsively generate calibrated images of the traffic scene from individual frames of the aerial video and determine unique keypoints on the vehicles in the traffic scene. In such an example, processing circuitry may track the vehicles across the individual frames of the aerial video utilizing the unique keypoints. Processing circuitry may output vehicle metrics for the vehicles.

### CLAIM OF PRIORITY

This application claims the benefit of U.S. Provisional Patent Application No. 63/500,720, filed 8 May 2023, the entire contents of which is incorporated herein by reference.

### TECHNICAL FIELD

Aspects of the invention relate generally to the field of computerized mapping, and more particularly, to systems, methods, and apparatuses for implementing a CAR-On-Map (“CAROM”) air framework for vehicle localization and traffic scene reconstruction using aerial video.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to embodiments of the claimed inventions.

Within the context of computing, computer cartography, computer mapping, digital mapping, or computerized mapping uses the speed and versatility of computer graphics to display spatial data. Digital map data consists of two fundamental types: vector and raster. The type of data determines how it will be stored and displayed. The basic principles of cartography apply to computer mapping, with some modifications.

Generally speaking, such mapping techniques collect spatial data which is then compiled and formatted into a virtual image using computing systems in an effort to produce maps that give accurate representations of a particular area, detailing major road arteries and other points of interest, as well as the ability to perform calculations of distances from one place to another.

### SUMMARY

In general, this disclosure is directed to improved techniques for implementing a CAR-On-Map (CAROM) air framework for vehicle localization and traffic scene reconstruction using aerial video as an input source.

Data-driven safety assessments for driving behaviors are helpful with generating and understanding insights into traffic accidents caused by dangerous driving behaviors. Meanwhile, quantifying driving safety through well-defined metrics in real-world naturalistic driving data is also helpful for the operational safety assessment of automated vehicles (AV). However, the lack of flexible data acquisition methods and fine-grained datasets has hindered progress in this area.

In response to this challenge, a novel dataset is described herein for driving safety metrics analysis specifically tailored to car-following situations. Leveraging state-of-the-art Artificial Intelligence (AI) technology, drones were utilized to capture high-resolution video data at twelve (12) traffic scenes (refer to FIGS. 11A, 11B, and 11C). Advanced computer vision algorithms and semantically annotated maps were utilized to extract vehicle trajectories and leader-follower relations among vehicles. These components, in conjunction with a set of defined metrics based on prior work on Operational Safety Assessment (OSA) by the Institute of Automated Mobility (IAM), allow a detailed analysis of driving safety to be conducted.

The results reveal the distribution of these metrics under various real-world car-following scenarios and characterize the impact of different parameters and thresholds in the metrics. By enabling a data-driven approach to address driving safety in car-following scenarios, the work can empower traffic operators and policymakers to make informed decisions and contribute to a safer, more efficient future for road transportation systems.

The present state of the art may therefore benefit from the systems, methods, and apparatuses for implementing the CAR-On-Map (“CAROM”) air framework for vehicle localization and traffic scene reconstruction using aerial video, as is described herein.

In at least one example, processing circuitry is configured to perform a method. Such a method may include processing circuitry executing instructions. In such an example, processing circuitry may obtain, as source input, aerial video of a traffic scene including vehicles that traverse the traffic scene and obtain a satellite map image of the traffic scene distinct from any aerial image of the traffic scene within the source input. In such an example, processing circuitry determines aerial image reference points of the traffic scene present within the source input which correspond to satellite map image reference points of the traffic scene present within the satellite map image of the traffic scene. Responsive to determining the aerial image reference points of the traffic scene present within the source input which correspond to satellite map image reference points of the traffic scene present within the satellite map image of the traffic scene, processing circuitry may generate calibrated images of the traffic scene from individual frames of the aerial video of the traffic scene by calibrating the individual frames of the aerial video with the satellite map image of the traffic scene utilizing the corresponding satellite map image reference points of the traffic scene. According to such an example, processing circuitry may determine multiple unique keypoints on the vehicles that traverse the traffic scene and in response to determining the multiple unique keypoints on the vehicles that traverse the traffic scene, processing circuitry may track the vehicles that traverse the traffic scene across the individual frames of the aerial video utilizing the multiple unique keypoints determined on the vehicles. In at least one example, processing circuitry outputs vehicle metrics for one or more of the vehicles that traverse the traffic scene.

In at least one example, a system includes processing circuitry; non-transitory computer readable media; and instructions that, when executed by the processing circuitry, configure the processing circuitry to perform operations. In such an example, processing circuitry may configure the system to obtain, as source input, aerial video of a traffic scene including vehicles that traverse the traffic scene and obtain a satellite map image of the traffic scene distinct from any aerial image of the traffic scene within the source input. In such an example, processing circuitry determines aerial image reference points of the traffic scene present within the source input which correspond to satellite map image reference points of the traffic scene present within the satellite map image of the traffic scene. Responsive to determining the aerial image reference points of the traffic scene present within the source input which correspond to satellite map image reference points of the traffic scene present within the satellite map image of the traffic scene, processing circuitry may generate calibrated images of the traffic scene from individual frames of the aerial video of the traffic scene by calibrating the individual frames of the aerial video with the satellite map image of the traffic scene utilizing the corresponding satellite map image reference points of the traffic scene. According to such an example, processing circuitry may determine multiple unique keypoints on the vehicles that traverse the traffic scene and in response to determining the multiple unique keypoints on the vehicles that traverse the traffic scene, processing circuitry may track the vehicles that traverse the traffic scene across the individual frames of the aerial video utilizing the multiple unique keypoints determined on the vehicles. In at least one example, processing circuitry outputs vehicle metrics for one or more of the vehicles that traverse the traffic scene.

In one example, there is computer-readable storage media having instructions that, when executed, configure processing circuitry to obtain, as source input, aerial video of a traffic scene including vehicles that traverse the traffic scene and obtain a satellite map image of the traffic scene distinct from any aerial image of the traffic scene within the source input. In such an example, processing circuitry determines aerial image reference points of the traffic scene present within the source input which correspond to satellite map image reference points of the traffic scene present within the satellite map image of the traffic scene. Responsive to determining the aerial image reference points of the traffic scene present within the source input which correspond to satellite map image reference points of the traffic scene present within the satellite map image of the traffic scene, processing circuitry may generate calibrated images of the traffic scene from individual frames of the aerial video of the traffic scene by calibrating the individual frames of the aerial video with the satellite map image of the traffic scene utilizing the corresponding satellite map image reference points of the traffic scene. According to such an example, processing circuitry may determine multiple unique keypoints on the vehicles that traverse the traffic scene and in response to determining the multiple unique keypoints on the vehicles that traverse the traffic scene, processing circuitry may track the vehicles that traverse the traffic scene across the individual frames of the aerial video utilizing the multiple unique keypoints determined on the vehicles. In at least one example, processing circuitry outputs vehicle metrics for one or more of the vehicles that traverse the traffic scene.

The details of one or more examples of the disclosure are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating further details of one example of computing device, in accordance with aspects of this disclosure.

FIG. 2A depicts traffic scenes from four scenario categories, in accordance with aspects of the disclosure.

FIG. 2B depicts the capture and identification of imagery utilizing CAROM Air framework 275, in accordance with aspects of the disclosure.

FIG. 2C depicts map calibration by CAROM Air framework 275, in accordance with aspects of the disclosure.

FIG. 2D depicts a pipeline of CAROM Air framework 275, in accordance with aspects of the disclosure.

FIG. 2E depicts specific vehicle keypoints 215 utilized by CAROM Air framework 275, in accordance with aspects of the disclosure.

FIG. 2F illustrates Table 1 at element 299 which provides keypoint 215 detection and keypoint 215 detection information for an input image, in accordance with aspects of the disclosure.

FIG. 3A depicts a simplified vehicle kinematic bicycle model 305 (left) and state prediction rules 310 (right), in accordance with aspects of the disclosure.

FIG. 3B sets forth Table 2 (parts 1 and 2 at elements 315A and 315B), providing tracking results of an evaluation, in accordance with aspects of the disclosure.

FIG. 3C sets forth Table 3 at element 320, providing model fitting results of an evaluation, in accordance with aspects of the disclosure.

FIG. 3D depicts a quantitative evaluation of the model fitting performance, in accordance with aspects of the disclosure.

FIG. 3E depicts location error in the vehicle frame, in accordance with aspects of the disclosure.

FIG. 4 depicts example trajectories and smoothing results, in accordance with aspects of the disclosure.

FIG. 5 depicts example maps of intersection scenes from a satellite image 505 (left) and semantic segmentation 510 to lane areas (right), in accordance with aspects of the disclosure.

FIG. 6 depicts an example of identified leader-follower vehicle pairs, in accordance with aspects of the disclosure.

FIG. 7 illustrates Table 4 at element 705 which provides Statistics of vehicle pairs and the number of data samples, in accordance with aspects of the disclosure.

FIGS. 8A, 8B, and 8C depict graphs showing distribution of vehicle speed, distribution of speed of leader-follower vehicle pairs, distribution of headway distance of leader-follower vehicle pairs, and distribution of Minimum Distance Safety Envelope (MDSE), in accordance with aspects of the disclosure.

FIG. 9A depicts graphs showing distribution of Minimum Distance Safety Envelope (MDSE), in accordance with aspects of the disclosure.

FIG. 9B depicts graphs showing distribution of MDSE ratios, in accordance with aspects of the disclosure.

FIG. 9C depicts graphs showing distribution of headway distance with respect to the follower vehicle speed, in accordance with aspects of the disclosure.

FIG. 10A depicts graphs showing histograms of inverse TTC for roundabouts and intersections, in accordance with aspects of the disclosure.

FIG. 10B depicts graphs showing histograms of inverse TTC for local road and highway segments, in accordance with aspects of the disclosure.

FIG. 10C depicts graphs showing histograms of MTTC for the four scenario categories, in accordance with aspects of the disclosure.

FIGS. 11A, 11B and 11C depict all twelve (12) traffic scenes utilized throughout the study, in accordance with aspects of the disclosure.

FIG. 12 depicts example applications of CAROM Air framework 275, in accordance with aspects of the disclosure.

FIG. 13 is a flow chart illustrating an example mode of operation for computing device 100 to implement a CAR-On-Map (“CAROM”) air framework for vehicle localization and traffic scene reconstruction using aerial video, in accordance with aspects of the disclosure.

Like reference characters denote like elements throughout the text and figures.

### DETAILED DESCRIPTION

Aspects of the disclosure describe improved techniques for implementing a CAR-On-Map (CAROM) air framework for vehicle localization and traffic scene reconstruction using aerial video as an input source.

Data-driven safety assessments for driving behaviors are helpful with generating and understanding insights into traffic accidents caused by dangerous driving behaviors.

Meanwhile, quantifying driving safety through well-defined metrics in real-world naturalistic driving data is also helpful for the operational safety assessment of automated vehicles (AV). However, the lack of flexible data acquisition methods and fine-grained datasets has hindered progress in this area.

Prior known techniques fail to account for more specific use cases, such as the reconstruction of a traffic scene or localization of specific vehicles from available data.

What is needed is an improved technique which enables users to target more niche scene reconstructions as well as localize specific vehicles from available data.

The present state of the art may therefore benefit from the systems, methods, and apparatuses for implementing a CAR-On-Map (“CAROM”) air framework for vehicle localization and traffic scene reconstruction using aerial video, as is described herein.

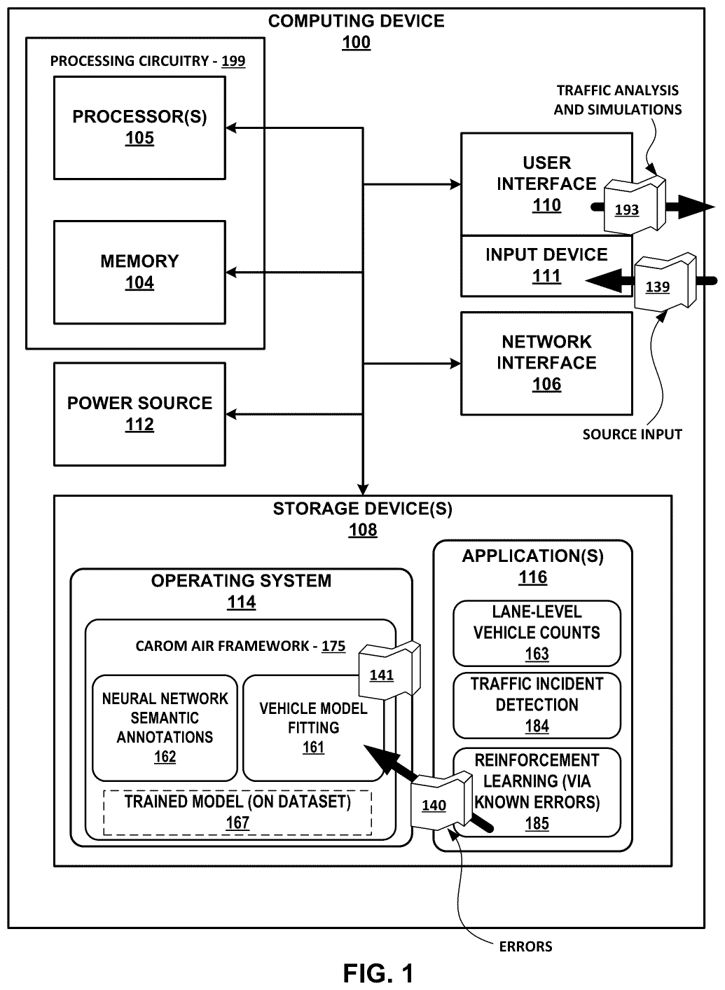

FIG. 1 is a block diagram illustrating further details of one example of computing device, in accordance with aspects of this disclosure. FIG. 1 illustrates only one particular example of computing device 100. Many other example embodiments of computing device 100 may be used in other instances.

As shown in the specific example of FIG. 1, computing device 100 may include processing circuitry 199 including one or more processors 105 and memory 104. Computing device 100 may further include network interface 106, one or more storage devices 108, user interface 110, and power source 112. Computing device 100 may also include an operating system 114. Computing device 100, in one example, may further include one or more applications 116, such as lane level vehicle counts 163, traffic incident detection 184, and reinforcement learning (via known errors) 185. One or more other applications 116 may also be executable by computing device 100. Components of computing device 100 may be interconnected (physically, communicatively, and/or operatively) for inter-component communications.

Operating system 114 may execute various functions including executing trained AI models and performing AI model training. As shown here, operating system 114 executes CAR-On-Map (CAROM) air framework 175 which includes both neural network semantic annotations 162 and vehicle model fitting 161, from which trained model 167 may be generated having been trained on a training dataset. Vehicle model fitting 161 may consume as input(s) vehicle priors 141 and errors 140 (e.g., known errors utilized for reinforcement learning provided by reinforcement learning 185 application 116 as output).

Computing device 100 may perform improved techniques for implementing a CAROM Air framework 275 including capturing and processing aerial video as source input 139 and providing various outputs including traffic analysis and simulations 193 via hardware of computing device 100 specially configured to perform the operations and methodologies described herein. Computing device 100 may receive source input 139 via input device 111 and provide traffic analysis and simulations 193 as output to a connected user device via user interface 110.

In some examples, processing circuitry including one or more processors 105, implements functionality and/or process instructions for execution within computing device 100. For example, one or more processors 105 may be capable of processing instructions stored in memory 104 and/or instructions stored on one or more storage devices 108.

Memory 104, in one example, may store information within computing device 100 during operation. Memory 104, in some examples, may represent a computer-readable storage medium. In some examples, memory 104 may be a temporary memory, meaning that a primary purpose of memory 104 may not be long-term storage. Memory 104, in some examples, may be described as a volatile memory, meaning that memory 104 may not maintain stored contents when computing device 100 is turned off. Examples of volatile memories may include random access memories (RAM), dynamic random-access memories (DRAM), static random-access memories (SRAM), and other forms of volatile memories. In some examples, memory 104 may be used to store program instructions for execution by one or more processors 105. Memory 104, in one example, may be used by software or applications running on computing device 100 (e.g., one or more applications 116) to temporarily store data and/or instructions during program execution.

One or more storage devices 108, in some examples, may also include one or more computer-readable storage media. One or more storage devices 108 may be configured to store larger amounts of information than memory 104. One or more storage devices 108 may further be configured for long-term storage of information. In some examples, one or more storage devices 108 may include non-volatile storage elements. Examples of such non-volatile storage elements may include magnetic hard disks, optical discs, floppy disks, Flash memories, or forms of electrically programmable memories (EPROM) or electrically erasable and programmable (EEPROM) memories.

Computing device 100, in some examples, may also include a network interface 106. Computing device 100, in such examples, may use network interface 106 to communicate with external devices via one or more networks, such as one or more wired or wireless networks. Network interface 106 may be a network interface card, such as an Ethernet card, an optical transceiver, a radio frequency transceiver, a cellular transceiver or cellular radio, or any other type of device that can send and receive information. Other examples of such network interfaces may include BLUETOOTH®, 3G, 4G, 1G, LTE, and WI-FI® radios in mobile computing devices as well as USB. In some examples, computing device 100 may use network interface 106 to wirelessly communicate with an external device such as a server, mobile phone, or other networked computing device.

User interface 110 may include one or more input devices 111, such as a touch-sensitive display. Input device 111, in some examples, may be configured to receive input from a user through tactile, electromagnetic, audio, and/or video feedback. Examples of input device 111 may include a touch-sensitive display, mouse, keyboard, voice responsive system, video camera, microphone or any other type of device for detecting gestures by a user. In some examples, a touch-sensitive display may include a presence-sensitive screen.

User interface 110 may also include one or more output devices, such as a display screen of a computing device or a touch-sensitive display, including a touch-sensitive display of a mobile computing device. One or more output devices, in some examples, may be configured to provide output to a user using tactile, audio, or video stimuli. One or more output devices, in one example, may include a display, sound card, a video graphics adapter card, or any other type of device for converting a signal into an appropriate form understandable to humans or machines. Additional examples of one or more output devices may include a speaker, a cathode ray tube (CRT) monitor, a liquid crystal display (LCD), or any other type of device that can generate intelligible output to a user.

Computing device 100, in some examples, may include power source 112, which may be rechargeable and provide power to computing device 100. Power source 112, in some examples, may be a battery made from nickel-cadmium, lithium-ion, or other suitable material.

Examples of computing device 100 may include operating system 114. Operating system 114 may be stored in one or more storage devices 108 and may control the operation of components of computing device 100. For example, operating system 114 may facilitate the interaction of one or more applications 116 with hardware components of computing device 100.

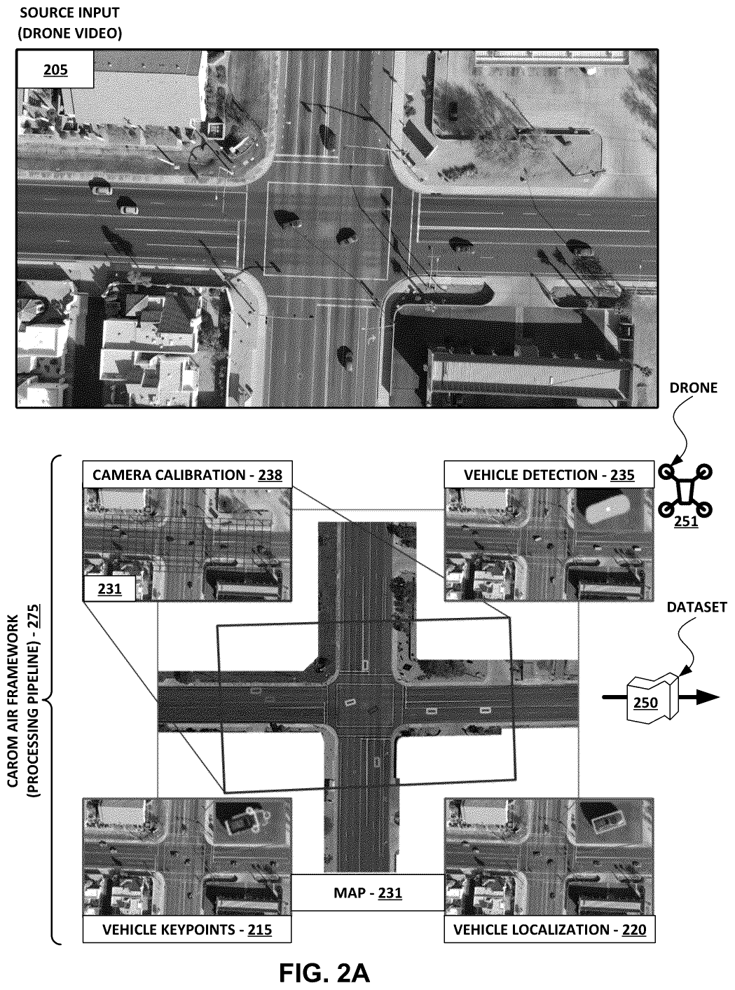

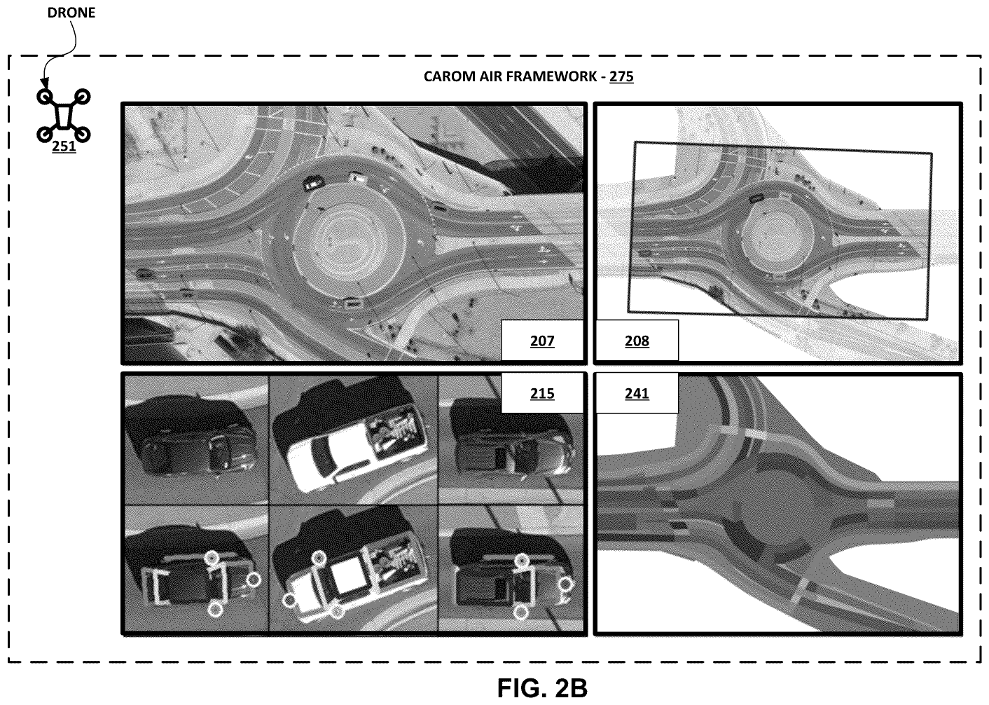

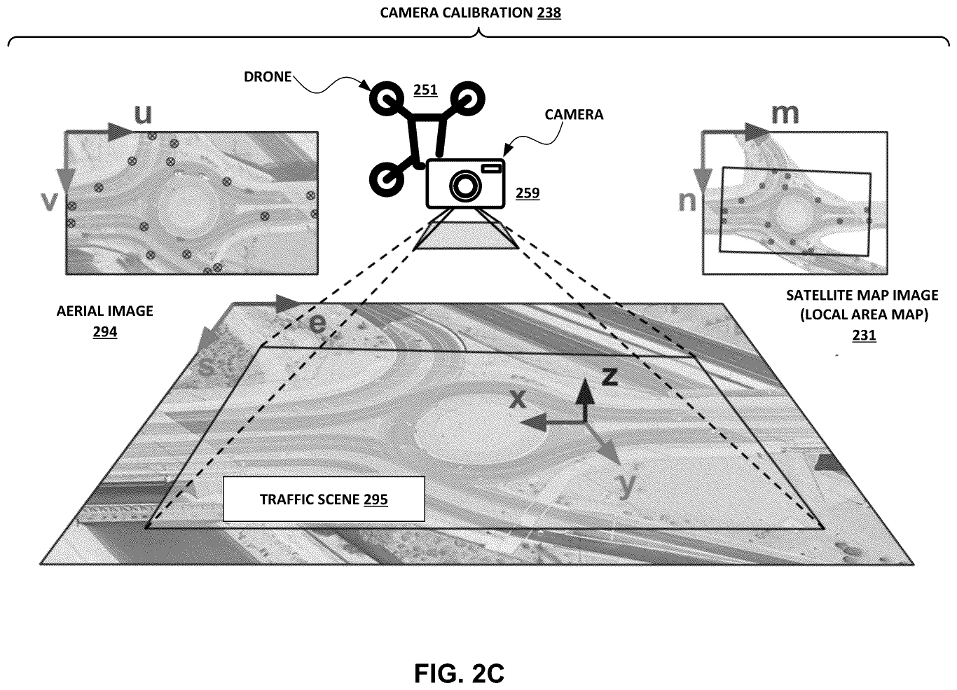

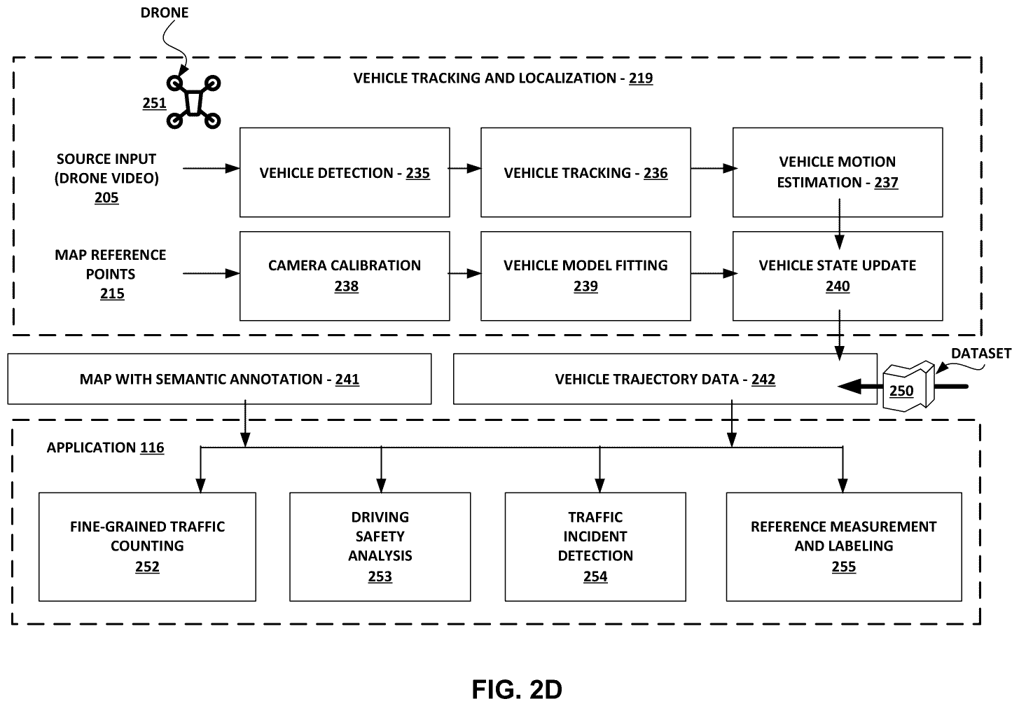

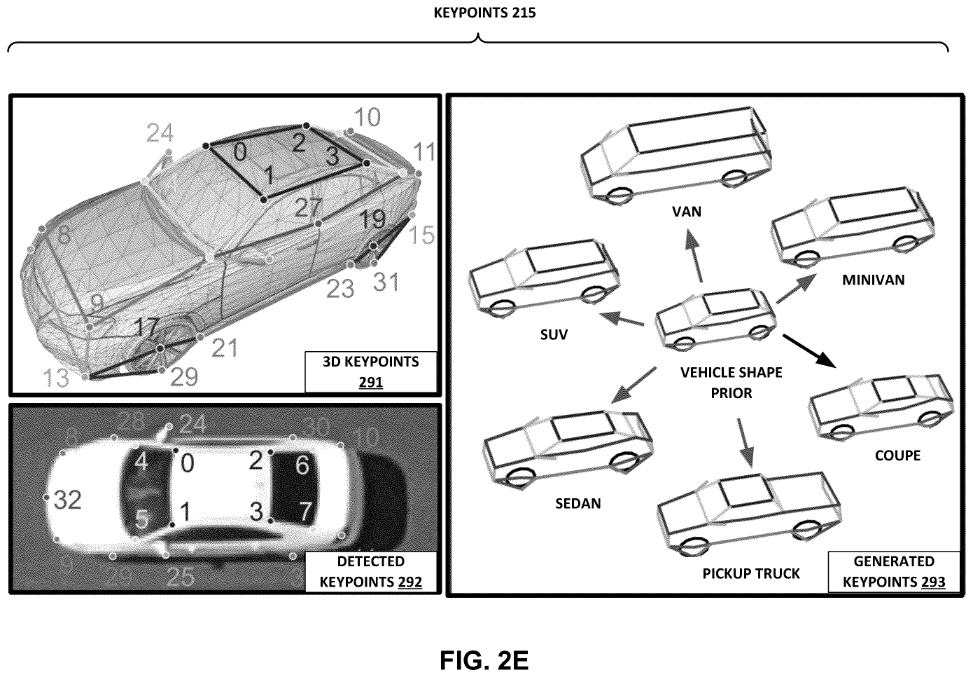

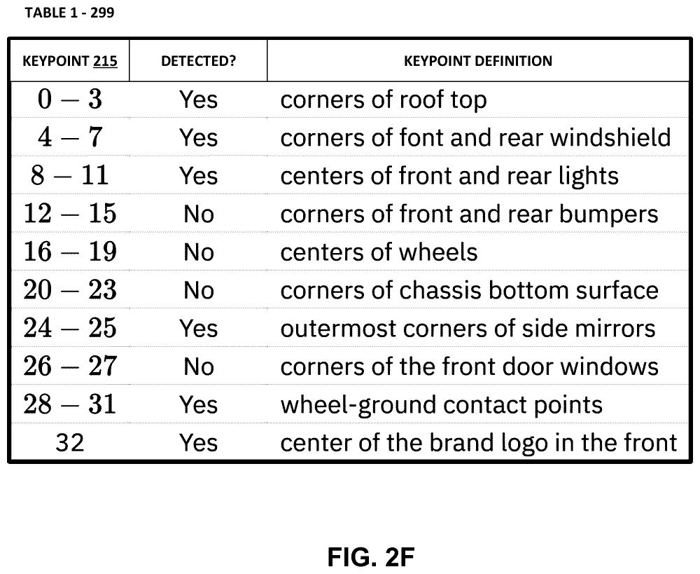

FIG. 2A depicts traffic scenes from four scenario categories, in accordance with aspects of the disclosure.

FIG. 2B depicts the capture and identification of imagery utilizing CAROM Air framework 275, in accordance with aspects of the disclosure.

FIG. 2C depicts map calibration by CAROM Air framework 275, in accordance with aspects of the disclosure.

FIG. 2D depicts a pipeline of CAROM Air framework 275, in accordance with aspects of the disclosure.

FIG. 2E depicts specific vehicle keypoints 215 utilized by CAROM Air framework 275, in accordance with aspects of the disclosure.

FIG. 2F illustrates Table 1 at clement 299 which provides keypoint 215 detection and keypoint 215 detection information for an input image, in accordance with aspects of the disclosure.

With reference to FIG. 2A, source input 205 is depicted, which may originate from drone 251 source input 205 video or other aerial video capture as a source input 205. Further depicted is satellite map 231 having certain portions removed for comparison with a reference image from source input 205. Four scenario categories are depicted including camera calibration 230, vehicle detection 235, vehicle keypoints 215, and vehicle localization 220.

Ensuring road safety is increasingly important in today's interconnected and technologically advanced world. Traffic accidents and dangerous driving behaviors remain significant challenges, and analyzing these issues with improved precision is an important step toward increasing road safety. Meanwhile, the rapid advancement of intelligent transportation systems provides opportunities innovative solutions for enhancing traffic situation awareness and vehicle-infrastructure coordination. Additionally, with the ongoing advancement of vehicles equipped with Automated Driving Systems (ADS), often denoted as “Automated Vehicles (AVs)”, there exists a growing imperative among industrial stakeholders to establish a reliable procedure for assessing the operational safety performance of these vehicles.

Such a procedure should offer a consistent, impartial, and technology-agnostic evaluation to instill public trust as automated vehicles become increasingly integrated into the transportation systems. However, there remain challenges in systematically performing driving safety assessments.

As one example, a primary roadblock is the development of objective and quantitative safety assessment methodologies that can be computed efficiently at the vehicle trajectory level (e.g., surrogate safety metrics) instead of incident level (e.g., counting and analyzing accidents). Such metrics may use precision measurements of the location and speed of a set of traffic participants all the time, which may be difficult to obtain.

As another example, established methodologies are preferably validated in various real-world traffic scenarios instead of simulations, especially from the perspective of traffic operators and policymakers instead of automated vehicle developers. Such a task may be improved with flexible, fine-grained data acquisition methods that can be easily deployed at any chosen traffic scene and datasets that cover a variety of traffic scenes. Such a comprehensive dataset is difficult to construct. As a result, for traffic researchers, the deficiency in data and analysis tools has hindered the advancement of road safety efforts.

To address these challenges, in 2020, the Institute of Automated Mobility (IAM) introduced a comprehensive set of operational safety assessment (OSA) metrics, representing a pioneering contribution that encompasses both automated vehicles and human-driven vehicles. Subsequent best practices were proposed by the Automated Vehicle Safety Consortium (AVSC) in 2021, aligning philosophically with many IAM OSA metrics. This industry-wide consensus has enabled the Society of Automotive Engineers (SAE) Vehicle and Vehicle (V&V) Task Force to embark on the development of a Recommended Practice for OSA metrics. These metrics form the cornerstone for the evaluation process, along with the development of the OSA Methodology by the IAM, slated for inclusion in future standards documentation.

Building upon this foundation, in 2021 and 2022, IAM researchers measured and evaluated a subset of the OSA metrics in simulation as well as using real-world data collected at an intersection, The focus is on safety envelope-type metrics within selected car-following scenarios from the list of pre-crash scenarios published by the National Highway Traffic Safety Administration (NHTSA).

At the heart of the OSA metrics research lies the recognition that without accurate vehicle localization and adequate vehicle trajectories, it is exceptionally challenging to calculate the needed metrics and to understand the complexities of road safety, especially in the context of car-following scenarios. In these scenarios, where vehicles closely trail one another, even the most minute driving behaviors are shown to have profound safety implications. To fill this data gap, IAM researchers developed camera-based traffic data acquisition methods from the perspective of infrastructure and drones in collaboration with Arizona State University and the University of Arizona.

Using advanced Artificial Intelligence (AI) algorithms and deep neural network models trained from large amounts of source input 205 data, these methods are enabled to obtain the vehicle trajectories on a map, which facilitates further analysis of driving behavior.

For instance, utilizing a drone data processing framework and drone 251 to capture aerial video imagery as source input 205, dataset 250 having approximately 100 hours of high-resolution traffic videos collected from various diverse sites was constructed.

Dataset 250 may enable the extraction of vehicle trajectories at the decimeter level and further support the analysis of operational safety assessment metrics.

According to described examples, processing circuitry 199 may automatically detect, determine, and identify leader-follower vehicle pairs from source input 205 using a computer program. The leader-follower vehicle pairs detected from source input 205 enables processing circuitry to process more than 1.2 million data samples from 5,433 pairs of vehicles efficiently in the example experiment performed.

Extending beyond prior studies, this validation and analysis delves into the distribution of a few driving safety metrics across various real-world car-following scenarios under a wide range of different scenes rather than one or a few scenes with limited data points. Moreover, metrics measurement data sheds light on how different parameters and thresholds impact these metrics. Furthermore, by integrating findings into the broader context of driving safety metrics for automated vehicles, the disclosed techniques strengthen the foundation for a comprehensive, data-driven approach to assess driving safety in car-following scenarios. The insights garnered from the research and experiments described herein not only empower traffic operators and policymakers to make informed decisions but also play a pivotal role in shaping the future of safety assessment of road transportation systems with automated vehicles.

### Traffic Scene Dataset 250

In one example, processing circuitry 199 obtained accurate vehicle trajectories from multiple traffic scenes to create dataset 250. In at least one example, processing circuitry 199 obtained vehicle trajectories twelve (12) different traffic scenes captured by source input 205 data (e.g., drone video) in the Phoenix metropolitan area, covering four different scene categories, including roundabouts, intersections, local road segments, and highway segments, with three scenes for each category.

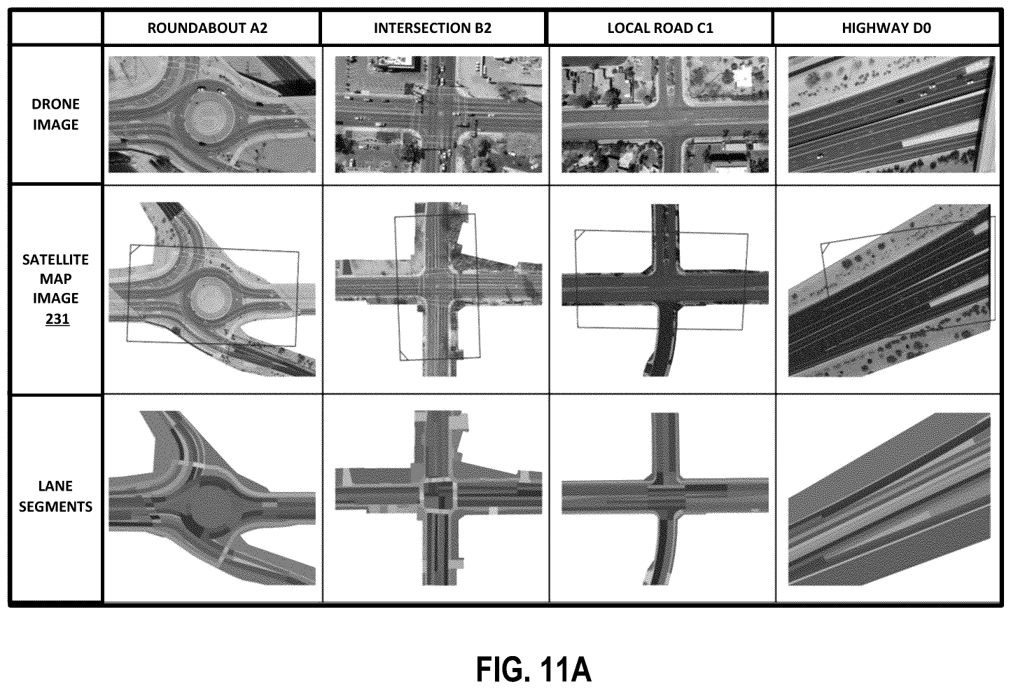

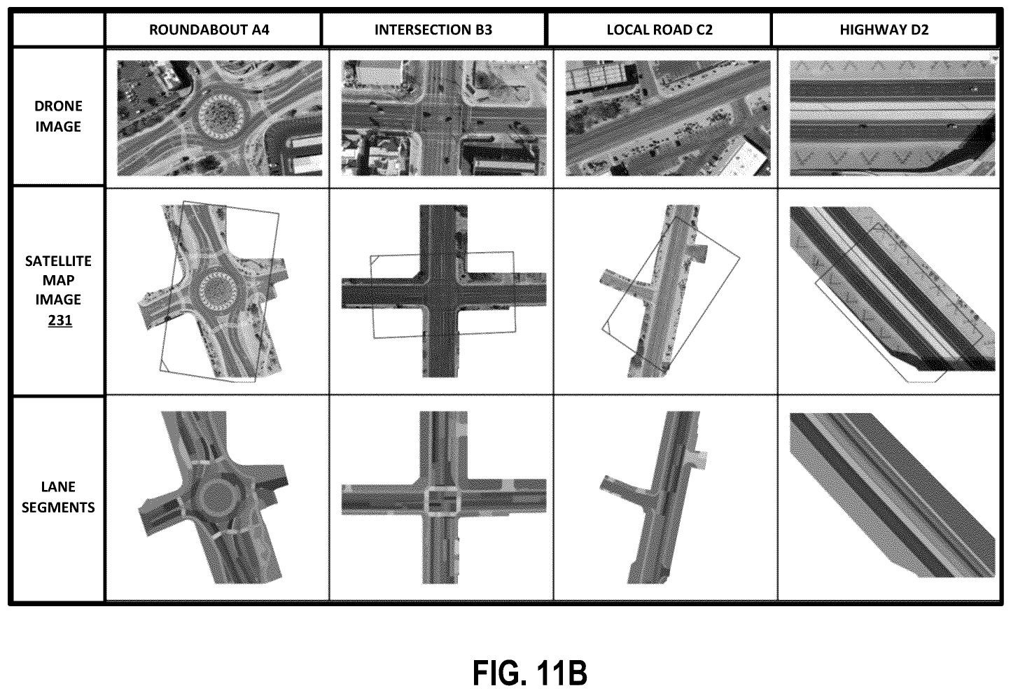

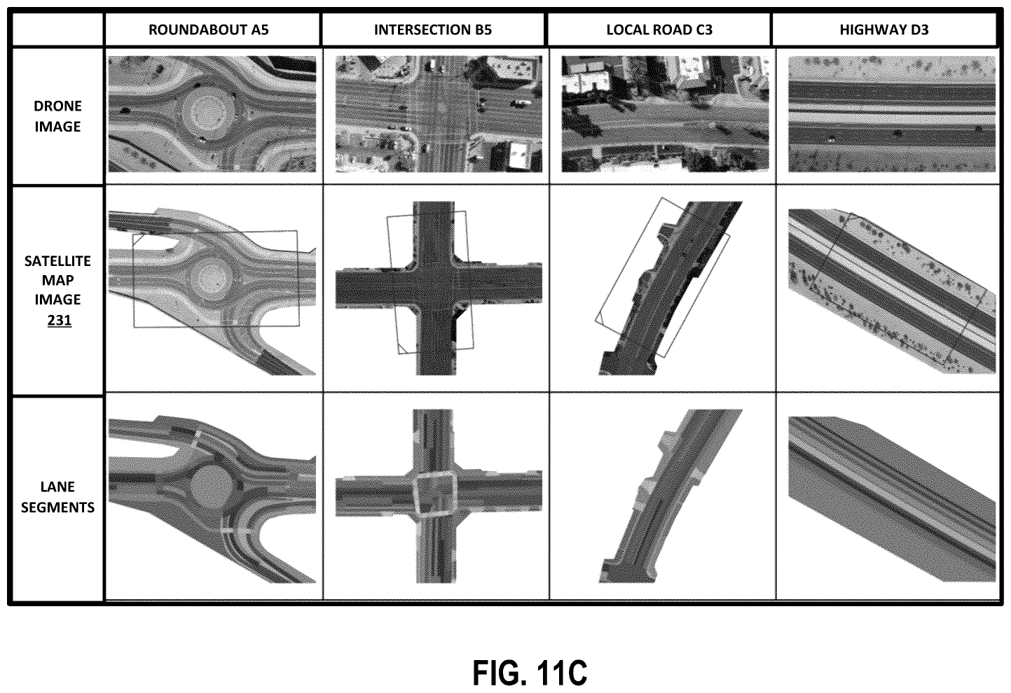

In such an example, a consumer-grade drone 251 (DJI Mavic Air 2) was flown at about 120 meters enabling processing circuitry to obtain a video track of about 21 minutes for each respective scene. During each data acquisition flight, drone 251 remained still to maintain its position and camera view angle. All 12 traffic scenes are provided at FIGS. 11A, 11B, and 11C. Processing circuitry processed source input 205 video data using CAROM Air framework 275 as depicted at FIG. 2A.

In at least one example, CAROM Air framework 275 utilities of a pipeline of four operations to track vehicles captured via source input 205 drone videos and obtain their trajectories in the 3D space.

For example, as depicted by FIG. 2B, in the upper left, tracked vehicles on the aerial video 207 are observed, in the top right, reconstructed traffic scene 208 on a map is depicted, in the lower left, vehicle keypoints 215 (refer to FIG. 2A) are depicted, and in the lower right, map with semantic annotation 241 (refer also to FIG. 2D) is depicted.

CAROM Air framework 275 (named “CARs On the Map tracked from the Air” or simply “CAROM Air”) digitizes and reconstructs road traffic scenes from aerial videos taken by drone 251. CAROM Air framework 275 provides inexpensive and flexible image capture, even in the absence of support from road infrastructure.

CAROM Air framework 275 provides a pipeline (see FIG. 2A and 2D) for vehicle tracking and localization 219 of vehicles detected within source input 205 aerial videos and localize such vehicles onto a map accurately through the detection of vehicle keypoints 215. This allows for a conversion of source input 205 aerial videos into vehicle trajectory data which can be delivered over communication networks for reconstruction or further analysis using complementary application(s) 116 (see FIG. 1) and processing circuitry 199.

Captured vehicle trajectory data does lacks personal identifiable information, and hence, such data may be shared without causing privacy issues. Moreover, captured data may be utilized as reference measurements and/or 3D labels for video data and LiDAR point clouds captured by devices on the road infrastructure.

CAROM Air framework 275 supports the development and validation of an operational safety assessment methodology and intelligent road traffic infrastructure. In such a way, CAROM Air framework 275 provides at least the following advantages: Firstly, a keypoint-based vehicle tracking and localization pipeline is described for use with source input 205 aerial videos. The average vehicle localization error is 0.1 m to 0.3 m using a drone 251 flying at 120 meters. Secondly, a dataset 250 of vehicle trajectories is provided, obtained from about 100 hours of drone video in 40 different scenes. Thirdly, each scene on map with semantic annotation 241 and segmentation data (see FIG. 2D) is provided at the lane level of the road which enables further automated traffic analysis and statistics. Fourthly, several downstream applications are demonstrated via the evaluations discussed below to directly benefit from the practicality of CAROM Air framework 275.

Road traffic has created societal problems that may benefit from study utilizing real-world road traffic data. For example, local Departments of Transportation (local DOTs) may have a need to count vehicles on every major road segment for traffic management purposes. Each counted vehicle in the data can have fine-grained attributes, such as vehicle type, speed, lane, etc. City planners and transportation system engineers may further seek to use detailed road traffic data for better decision-making and resource provisioning. Additionally, for researchers and regulators interested in road safety analysis and driver behavior modeling, it may be more valuable to capture comprehensive motion states of vehicles passing through a specific traffic scene rather than merely obtaining a simple count (which does not carry much information) or a crash report (which happen infrequently). For example, aggressive lane switches and frequent close call incidents on a highway segment may indicate that the traffic is reaching design capacity.

Similarly, reckless driving behaviors can reveal more insights on road safety than reported accidents. In addition to the needs of the policy makers, vehicle manufacturers and insurance companies may also benefit from datasets 250 (see FIG. 2A) of vehicle trajectories, especially if such data can be used to accurately reconstruct and re-simulate the captured traffic scenes.

Traditionally, such road traffic data is collected and managed by DOTs using devices installed on the road infrastructure. However, such techniques are expensive as not every mile of a road is equipped with sensors and cameras. As a result, many traffic scenes of interest are not captured. Although many cameras are deployed in strategic locations in major cities, the sheer quantity of video data that needs to be delivered over the network and subsequently processed is not only computationally burdensome but in practice is simply infeasible for most traffic jurisdictions. The operational cost of such cameras further hinders large-scale deployment. Meanwhile, since the cameras are immobile, captured video data contains redundant information from repeated patterns. Further still, vehicle localization 220 performance of infrastructure-based sensors significantly degraded when a tracked vehicle is far away or occluded by other vehicles. Additionally, due to regulations and privacy issues, local DOTs may be statutorily prohibited from sharing video data with external researchers or industrial partners.

From a non-governmental perspective, it is expensive for independent researchers or companies to collect and manage road traffic data. Even for those researchers and companies who can afford to collect data on the road using cameras and LiDAR sensors, it is time-consuming to label the data to train models effectively, particularly if the labeling is done in the 3D space to support the AI model which is processing or consuming the 3D space data as training input.

Unmanned Aerial Vehicles (UAVs), commonly called drones 251, have been used in 3D mapping of road infrastructure, traffic monitoring, road safety analysis, and transportation of humans and goods. Drones 251 provide an inexpensive and flexible method of obtaining aerial videos of road traffic scenes for use as input data 205. To further process input data 205 from drone 251 video, a pipeline of vehicle detection and tracking capabilities provided by CAROM Air framework 275 is applied. CAROM Air framework 275 may utilize deep neural networks for the processing of input data 205. The generated vehicle trajectories further drive a series of analysis tasks with the use of a map having lane-level traffic semantics. Additionally, publicly available datasets representing vehicle trajectories obtained from drone videos may supplement existing large-scale autonomous driving datasets and traffic monitoring datasets obtained from road infrastructure.

CAROM Air framework 275 provides unique features which extend well beyond all prior known systems and thus, yields improved effectiveness over all prior known systems. Specifically, the keypoint 215 based vehicle tracking and localization 219 in conjunction with 3D shape estimation provides better accuracy and more flexibility in drone 251 camera perspective angles. Distinct from prior attempts at vehicle tracking and 3D pose estimation for use with autonomous driving and computer vision, disclosed techniques differ from prior known solutions which use 3D sensors (i.e., LiDAR). Stated differently, CAROM Air framework 275 functions successfully with only a monocular drone camera and a shape prior model. CAROM Air framework 275 operates successfully in the absence of 3D sensor data, but may be extended to consume such 3D sensor data as a supplemental but optional input.

### Carom Air Framework

With reference to FIG. 2D, three layers of CAROM Air framework 275 are depicted, including a foundational vehicle tracking and localization 219 layer establishing the pipeline CAROM Air framework 275 utilized to track and localize vehicles captured within source input 205 drone and/or aerial video. The middle layer corresponds to dataset 250 providing tracked vehicle trajectory data 242 and traffic scene maps with semantic annotation 241 including lane-level semantic annotations according to certain examples. Downstream application(s) 116 (refer also to FIG. 1) form a third layer of CAROM Air framework 275.

Within vehicle tracking and localization 219 pipeline operations include vehicle detection 235, vehicle tracking 236, vehicle motion estimation 237, each of which collectively feed into vehicle state update 240 operation as input. Map reference points 206 are obtained by processing circuitry 199 which are subsequently utilized for calibration 238, vehicle model fitting 239, and vehicle state update 240, each of which may form at least a portion of dataset 250 within vehicle trajectory data 242. Camera calibration 238 operations are depicted in greater detail at FIG. 2C. For instance, a pinhole camera model with no distortion and a flat ground model may be utilized, which will generally provide sufficient accuracy.

Different from a stationary camera installed on the road infrastructure, the pose of drone 251 and the camera can drift. Hence, recalibration may be performed for video images within source input 205 drone video on a periodic basis. In one example of performing a recalibration, processing circuitry 199 may detect corner features on the ground as map reference points 206 for the respective aerial image from source input 205 and track those map reference points 206 across the entirety of the source input 205 drone video (e.g., across all image frames) and re-compute the camera pose of drone 251 using PnP. The semantic annotation of satellite map 231 may enable processing circuitry 199 to determine map reference points 206 on the ground. Having the camera parameters and map reference points 206, processing circuitry 199 may then back-project any image pixel to a 3D location if that pixel is on the ground.

In certain examples, for each video track of source input 205, 8 to 16 point correspondences may be annotated on a satellite map 231 (e.g., a screenshot on Google Maps) and a reference aerial image, which is may be the first image embodied within source input 205 video. Having obtained map reference points 206 correspondences, processing circuitry 199 solves for a 3D pose of the camera of the drone utilizing Perspective-n-Points (PnP) given a priori knowledge of the camera intrinsics. For instance, camera intrinsics may be pre-calibrated in a lab provided via a certified calibration source. Processing circuitry 199 computes the 3D coordinates of map reference points 206 using the scale of satellite map 231, for instance, by assuming the annotated map reference points 206 are on flat ground.

In one example, four operations of CAROM Air framework 275 form a processing pipeline, set forth as follows:

Camera calibration 238: With reference to FIG. 2C, utilizing camera calibration 238 operation, processing circuitry may obtain satellite map image 231 of each traffic scene 295. For example, camera calibration 238 may obtain satellite map images 231 from a screenshot through online map services such as Google Maps or Microsoft Bing Maps providing a reference image to a local area map. A first image from source input 205 drone video and satellite map image 231 may then be calibrated via camera calibration 238 to set up pixel-to-pixel coordinate transformation.

Processing circuitry 199 may assume the vehicle-traversable road areas covered by source input 205 drone video are on flat ground for all the traffic scenes 295. This assumption only causes negligible vehicle localization errors. Camera calibration 238 operation also sets up a 3D reference frame relative to satellite map 231. Utilizing satellite map 231 image which is to scale and has a relatively high resolution (approximately 6˜7 cm per pixel), processing circuitry is enabled to measure locations and distances precisely at the decimeter level.

Responsive to source input 205 drone video and satellite map 231 being successfully calibrated, CAROM Air framework 275 pipeline processes each video image in the sequence available from source input 205 drone video. To compensate for drift of the camera 259 and other flight instability motions of drone 251 during the video recording, CAROM Air framework 275 pipeline may track lane marker features on the ground within source input 205 drone video. For instance, processing circuitry may estimate a 3D pose of a camera of drone 251 for each video image within source input 205 drone video and correct the coordinate system transformation relative to calibrated and/or annotated first image of source input 205 drone video (e.g., satellite map 231 previously calibrated to a first image of source input 205 drone video).

Vehicle detection 235: Utilizing vehicle detection 235 operation, processing circuitry may train a deep neural network based on Mask R-CNN to detect the 2D bounding box, instance segmentation mask, and determine key points 215 of each vehicle within every video image of source input 205. In such examples, key points 215 include observable features such as corners of the front and rear windshields, lights, bumpers, mirrors, etc.

In at least one example, 19 key points 215 are detected in total. Given the same vehicle detected on two adjacent video images, processing circuitry 199 may check overlap and color consistency of the bounding boxes to associate or otherwise correlate map reference points 206 of the bounding boxes across adjacent video images.

In certain examples, responsive to detecting and associating vehicles identified within source input 205 video images, each uniquely identified vehicle is assigned a unique vehicle identifier (ID). Experimental evaluation shows that the described pipeline of CAROM Air framework 275 reliably detects about 94% of vehicles.

In one example, a keypoint 215 RCNN detects vehicle keypoints 215 and bounding boxes on each image. For instance, FIG. 2E depicts over 30 keypoints 215 via 3D keypoints 291. Refer also to the listing of keypoints 215 by Table 1 (element 299 of FIG. 2F).

Keypoints 215 may be defined in groups of two (e.g., right-left) or four (e.g., front-right, front-left, rear-right, and rear-left). Among them, 19 detected keypoints 292 are depicted via the image shown at FIG. 2E.

The detected keypoints 215 are listed in the middle column as either detected or not detected for a given input image. Keypoint 215 data in the left column provides the specific point corresponding to those keypoints 215 of FIG. 2E, and the right most column provides a definition of the various keypoints 215.

Keypoints 215 are usually related to observable features such as corners which are more reliably detected utilizing a Keypoint RCNN. In the evaluations, a Keypoint RCNN was trained from a small dataset constructed for the sake of evaluation of 4,386 images, and about 12,000 vehicles in total. With the detected vehicle object instances on two adjacent video frames, the vehicles were associated when the intersection-over-union (IoU) of their respective bounding boxes exceeded a certain threshold (e.g., tracking by detection).

Keypoint detection, also known as keypoint localization or landmark detection, is a computer vision task that involves identifying and localizing specific points of interest in an image. In computer vision tasks, keypoints represent human body joints, facial landmarks, or salient points on objects.

Keypoint 215 detection provides information about the location, pose, and structure of objects or entities within an image, thus fulfilling an important role in computer vision applications including pose estimation, object detection and tracking, facial analysis, augmented reality, and keypoint 215 detection on groups of people.

Deep learning-based approaches to keypoint detection in objects use convolutional neural networks (CNNs), such as a high resolution deep learning network (e.g., HRNet). Custom object keypoint 215 detectors may be trained or transfer learning may be utilized to modify a pretrained keypoint 215 detector and fine-tune it for a specific application.

More particularly, a Region-based Convolutional Neural Network (R-CNN or RCNN) is a type of machine learning model that uses deep learning architecture for computer vision tasks, such as object detection. R-CNN is a two-stage detection algorithm that combines rectangular region proposals with convolutional neural network features. The three variants of R-CNN optimize, speed up, or enhance finding regions in an image that might contain an object, extracting CNN features from the region proposals, and classifying the objects using the extracted features. In at least one example, CAROM Air framework 275 applies an RCNN to object detection and tracking operations for individual image frames of the source input 205 drone video.

Vehicle model fitting 239: In at least one example, processing circuitry 199 constructs a morphable vehicle model using 33 skeleton vertices from statistical analysis of 200 vehicle 3D models collected from the Internet. These 3D models are manually built by artists for games and 3D animations. The example morphable model can be controlled by five parameters to change its shape to approximate a variety of real-world vehicles, including sedans, coupes, SUVs, mini-vans, vans, and pickup trucks. After that, processing circuitry 199 may fit the shape onto each detected vehicle on every 2D video image following the camera perspective geometry. In such examples, processing circuitry 199 executes an algorithm to solve the shape, location, and orientation of the morphable vehicle model such that the projected 3D skeleton vertices of the model best match the 2D key points detected on the image. Utilizing such a 3D morphable vehicle model is the key to allowing the pipeline to achieve decimeter-level vehicle localization accuracy in most cases, which further enables driving safety metrics calculation and analysis.

With reference to FIG. 2E, there are further depicted 3D keypoints 291 which are defined in 3D, detected keypoints 292 which are detected from an image capture within source input 204, and generated keypoints 293 generated from a vehicle shape prior model (e.g., known a priori).

For instance, over 200 vehicle 3D models were collected from various sources and then annotated for all 33 keypoints 215 in 3D for each model. These 3D models included vehicles of various types such as those depicted at FIG. 2E, generated keypoints 293. For instance, generated keypoints 293 based on the vehicle shape prior included a van, minivan, coupe, pickup truck, sedan, and an SUV. The 3D models were preprocessed to the actual scale of real-world vehicles.

For each vehicle model, the (x, y, z) coordinates of all 33 annotated 3D keypoints were concatenated as a long vector (denoted as the shape vector Sᵢ).

Next, Principal Component Analysis (PCA) was run on the set of shape vectors {sᵢ} of all vehicles to find the mean shape sₘ, the k basis vectors (denoted as the columns of a matrix W) corresponding to the k largest eigen values, and the k-dimensional parameter vectors {bᵢ}, such that the reconstructed shapes {ŝᵢ=Wbᵢ+sₘ} can approximate the original shapes {sᵢ}.

Similarly, the method can generate a vehicle shape ŝ*+=Wb*+sₘ from an arbitrary parameter vector b. Shapes of vehicles of various types can be generated in this way, as at FIG. 2E, generated keypoints 293. The mean shape vector sₘ and the matrix W are collectively called the vehicle shape prior.

Given a vehicle on an image, the disclose method operates to find (or attempt to find) a parameter vector b and the vehicle pose (R, t), such that the generated vehicle shape best fits the detected keypoints p under the camera projection Π() obtained from recalibration, set forth according the following equation:

$${arg min}_{b , R , t} {\sum }_{j}^{N} {α}^{( j )} ‖ {p}^{( j )} - \prod ( R ( {W}^{( j )} b + {s}_{m}^{( j )} ) + t ) ‖ + λ ‖ b - {b}_{t} ‖ ,$$

where N is the total number of detected keypoints (19 as used herein); where α^{(j)} is the visibility of the jth keypoint reported by the detector, e.g., either 1 (visible) or 0 (invisible); where p(j) is the pixel coordinates of the jth keypoint; and where W^{(j)} and sₘ^{(j)} are the vehicle shape prior components for the jth keypoint.

Assuming the vehicle is always on the flat ground (e.g., the XOY plane), there are three unknown variables in the vehicle pose. Specifically, the vehicle position (x, y) in t and the heading angle ψ in R, where R is the rotation matrix along the z-axis by the angle ψ. With this parameterization, vehicle model fitting 239 problem is an unconstrained nonlinear least square problem, which can be solved efficiently using the Levenberg-Marquardt method.

The initial position of the vehicle is approximated by the center of the bounding box, and the initial heading of the vehicle is obtained using a set of vectors through random sample consensus (RANSAC). These vectors are derived from a set of keypoint pairs pointing in the vehicle's forward direction, such as {(0,2), (1,3), (4,6), (8,10), . . . }.

In fact, since Π() is close to a weak perspective projection for aerial videos, if the initial estimation of the vehicle heading is reasonably accurate (which is usually the case), this problem is very close to a linear least squares problem. Hence, it generally converges very fast (sub-millisecond in the disclosed implementation).

The last term λ∥b-bₜ∥ is a regularizer, where bₜ is the categorical “template” parameter vector. For example, if the vehicle is detected as a sedan, bₜ is the average of {bᵢ} from all sedans among the 200 vehicle 3D models that are used to construct the vehicle shape prior. Meanwhile, bₜ is also used as the initial value of b in the optimization procedure. After the model fitting, the k-nearest-neighbor of b is found in {bᵢ} and used to determine the type of the vehicle.

Vehicle motion estimation 237: With reference again to FIG. 2D, processing circuitry 199 may track each detected vehicle in the 3D space and continuously estimate its location and orientation, image by image. For instance, vehicles may be tracked using an Extended Kalman Filter (EKF) in a simplified vehicle kinematic bicycle model.

Vehicle motion estimation 237 allows CAROM Air framework 275 pipeline to recover from occasional misdetection of vehicle instances on some video images within input data 205. Moreover, vehicle motion estimation 237 further enables processing circuitry 199 to obtain other vehicle motion states, such as velocity and acceleration, beyond just location and orientation.

Given kinematic states for a particular vehicle, vehicle motion estimation 237 operations may save the kinematic states into a file. Subsequent to source input 205 video being fully processed, processing circuitry 199 may use the saved kinematic states of vehicles to reconstruct the trajectory and export them together with the map as the traffic scene datasets as part of a simulation.

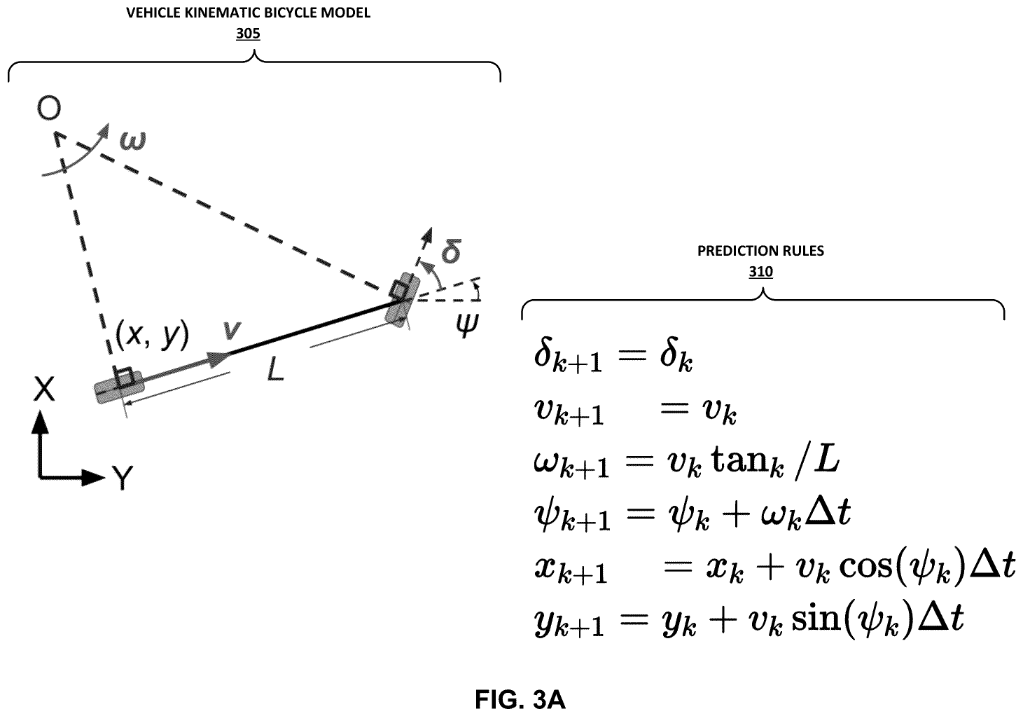

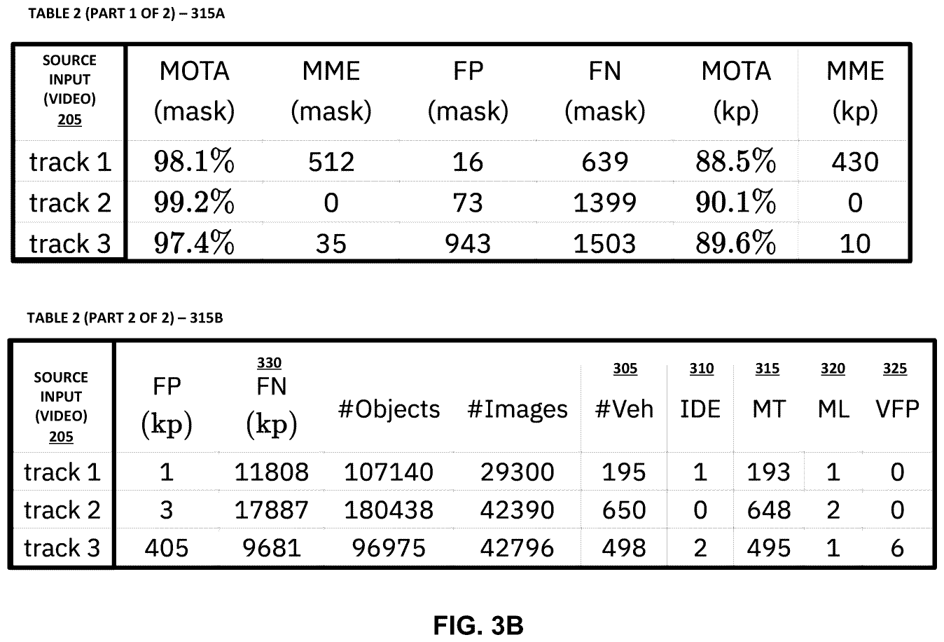

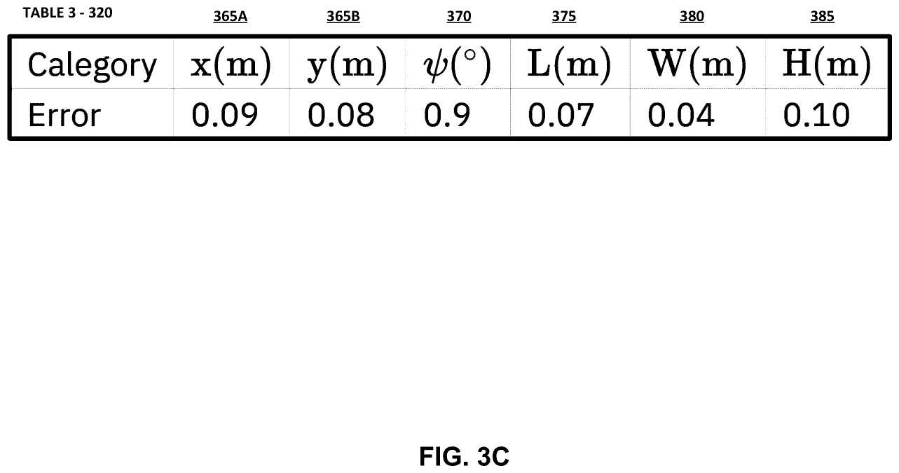

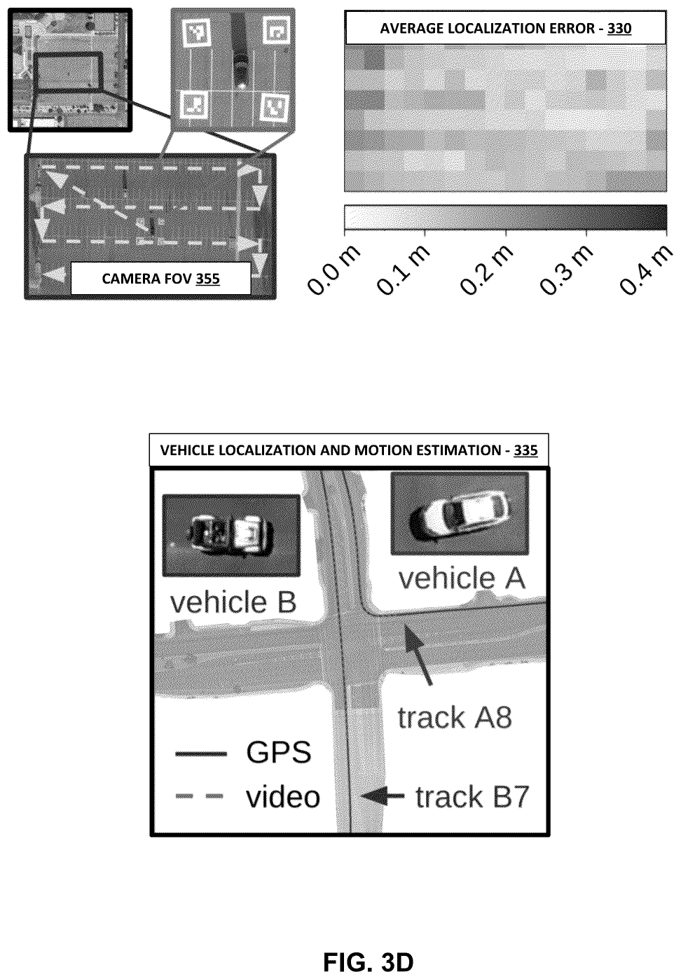

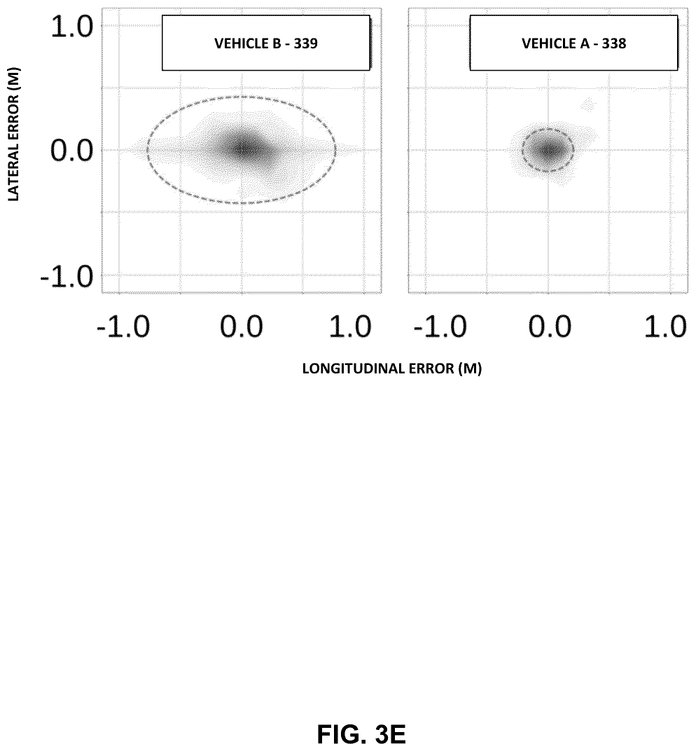

FIG. 3A depicts a simplified vehicle kinematic bicycle model 305 (left) and state prediction rules 310 (right), in accordance with aspects of the disclosure.

FIG. 3B sets forth Table 2 (parts 1 and 2 at elements 315A and 315B), providing tracking results of an evaluation, in accordance with aspects of the disclosure.

FIG. 3C sets forth Table 3 at element 320, providing model fitting results of an evaluation, in accordance with aspects of the disclosure.

Processing circuitry, utilizing vehicle model fitting 239 (see FIG. 2D) provides the position and heading of each detected vehicle on every image of the source input 205 aerial video. Processing circuitry further computes velocity of each vehicle using the motion of keypoints 215 on adjacent video images and the frame rate. After that, an Extended Kalman Filter (EKF) is executed with a simplified kinematic bicycle model 305, as illustrated in FIG. 3A.

Vehicle state prediction rules 310 are listed by equations (1) to (7) at FIG. 3A. Processing circuitry may assume that a vehicle maintains its steering angle and speed, according to equations 1, 2, and 3, set forth as follows:

$${δ}_{k + 1} = {δ}_{k} ; \qquad ( equation 1 )$$

$${v}_{k + 1} = {v}_{k} ; \qquad ( equation 2 )$$

$$and$$

$${ω}_{k + 1} = {v}_{k} tan {δ}_{k} / L . \qquad ( equation 3 )$$

Among all the states, the position (x, y), heading ψ, and velocity v are considered directly observable. The parameter vector b and the vehicle dimension are also estimated iteratively using the model fitting results. Since the vehicle motion and rotation between two adjacent frames is generally small and the estimator runs on each frame, the EKF approximation works well. Finally, the estimated states of all vehicles on all video images are exported as the road traffic metadata represented by Table 2, parts 1 and 2 (elements 315A and 315B) at FIG. 3B.

Example Implementation Details: A prototype system was built that implements the proposed framework with a few small improvements. First, for some scenes, a piecewise flat ground model was used to better capture the uneven ground surface. The added cost is that more reference point 206 correspondences are annotated at carefully chosen places. Second, camera recalibration 238 was augmented to a sparse monocular Simultaneous Localization And Mapping (“SLAM”) pipeline with key frame 215 selection to improve the robustness. Third, a backup vehicle tracking and localization 219 pipeline was implemented using the instance segmentation masks of vehicles (e.g., derived maps with segmentation annotation 241 data). When the keypoint 215 detector misses a vehicle but the mask detector detects it, this backup pipeline operates to correct the conflicting information resulting in the error. Two additional estimators were implemented for the backup pipeline. When the vehicle heading can be obtained, an EKF with a point-mass and no-side-slip kinematic model was used. If the heading cannot be obtained, then a Kalman Filter estimator is used instead to provide the value.

### Empirical Evaluation

Several experiments were conducted to evaluate CAROM Air framework 275 and the example implementation. With reference again to Table 2, parts 1 and 2 (element 315A and 315B) as depicted by FIG. 3B, source video 205 includes three video tracks taken from three different scenes. Vehicle detection and tracking performance were evaluated with the results depicted at Table 2. As depicted, “#Veh” (305) is the number of vehicles in the video track; “IDE” 310 is the number of vehicles with tracking ID errors; “MT” 315 is the number of vehicles that are tracked for over 80% of the time (i.e., “mostly tracked”); “ML” 320 is the number of vehicles that are tracked for less than 20% of the time (i.e., “mostly lost”); “VFP” 325 is the number of non-vehicle objects that are wrongly tracked as vehicles (i.e., “vehicle false positive”). A vehicle is considered “tracked” if it is either tracked by the normal pipeline (using the keypoints 215) or the backup pipeline (using the mask). Processing circuitry only tracked vehicles on the traversable ground area labeled on the map. Processing circuitry only assigned a tracking ID to a vehicle if the vehicle can be detected and associated for at least five consecutive video images within the source input 205.

A strict score threshold was set for the keypoint detector so that there were less false positives and more false negatives (as shown in the “FN (kp)” 330 column. In most cases, these false negatives can be handled by the backup pipeline with slight loss of vehicle localization accuracy. Overall, the prototype tracks most of the vehicles correctly.

FIG. 3D depicts a quantitative evaluation of the model fitting performance, in accordance with aspects of the disclosure.

Camera field of view (FOV) 355 depicts a parked test vehicle in an empty lot. Drone 251 was flown over the parked test vehicle 85 meters. Drone 251 was moved such that the parked test vehicle can be seen in different places in the camera field of view 355, which is illustrated as the dashed trajectory line in camera field of view 355. Four large ArUco markers were placed on the ground to facilitate camera recalibration 238. Three different test vehicles with known dimensions were used (a sedan, a hatchback, and an SUV), and six video tracks were collected as source input 205 (20 minutes in total). For each video track of the source input 205, the four contact points of the wheels and the ground were marked to derive ground truth for each vehicle pose.

With reference to FIG. 3C, the evaluation results provided at Table 3 (320), provide averaging over all images from all video tracks. The first two columns of Table 3 represent the position error 365 in the vehicle's longitudinal direction (x) and lateral direction (y) at columns 365A and 365B, respectively. The third column 370 represents the heading angle error in degrees. The last three columns represent the vehicle dimension error in length (375), width (380), and height (385), respectively, each provided in meters.

Referring again to FIG. 3D, average localization error 330 is depicted across the camera FOV 355. These results demonstrate that the vehicle pose and shape can be captured precisely.

Performance of vehicle localization and motion estimation 335 was further evaluated. As shown in FIG. 3D, two test vehicles equipped with differential GPS devices were driven through an intersection. When compared with the GPS data, the results obtained from drone 251 at 120 meters exhibited differential GPS localization accuracy of about 2 cm. The differential GPS measurements were then used as references. As part of the evaluation, each test vehicle was driven across the intersection 24 times in various directions. Two example trajectories are shown by vehicle localization and motion estimation 335. The example prototype implementation demonstrates that keypoints 215 of vehicle A can be reliably detected all the time using the normal pipeline of CAROM Air framework 275. In contrast, keypoints 215 of vehicle B can only be detected occasionally, and the backup pipeline was used most of the time.

FIG. 3E depicts location error in the vehicle frame, in accordance with aspects of the disclosure.

The average location error utilizing CAROM Air framework 275 and the reference measurements were 0.10 m and 0.26 m for vehicle A (338) and vehicle B (339), respectively. The average speed estimation error between CAROM Air framework 275 and the reference measurements were 0.22 m/s and 0.36 m/s for vehicle A (338) and vehicle B (339), respectively. Additionally, the distribution of localization error in the vehicle's reference frame is shown, in which the bold dotted-line ellipses represent the approximated two-sigma range, i.e., about 95% of the errors are inside the ovals. These results indicate that CAROM Air framework 275 accurately tracks and localizes vehicles. Sources of errors include the following: (a) camera lens distortion, (b) inaccurate drone camera pose estimation in recalibration, (c) ground flatness, and (d) keypoint 215 detection errors. In some cases, under strong sunlight, the detector may also error due to featureless black vehicles, vehicle shadows, and specular reflection on the vehicle surface.

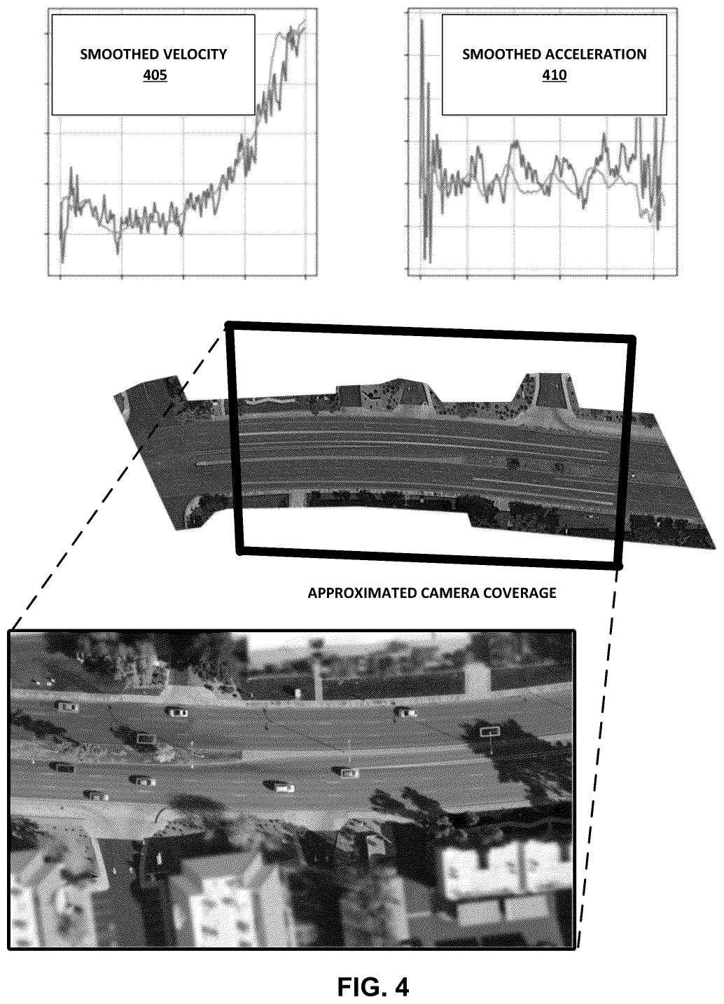

FIG. 4 depicts example trajectories and smoothing results, in accordance with aspects of the disclosure.

### Vehicle Trajectory Postprocess

According to one example, processing circuitry 199 computes the driving safety assessment metrics for a variety of car following scenarios. For instance, processing circuitry 199 derives vehicle leader-follower pairs and vehicle motion states (e.g., speed and acceleration) beyond the trajectory of individual vehicles. Processing circuitry 199 may execute three post-processing stages to achieve this goal: trajectory smoothing, automated leader-follower identification, and pair filtering.

Trajectory Smoothing: Given a vehicle trajectory with vehicle locations and orientations, processing circuitry 199 may smooth each trajectory point and estimate the speed and acceleration by fitting a quadratic curve on the trajectory within a sliding window.

Examples of vehicle trajectories and smoothing results are shown in FIG. 4, in which there are three operations applied.

First, given a vehicle trajectory consisting of a sequence of location points, for each location point, processing circuitry 199 may take a segment of the trajectory centered at that location point. Since the trajectory is obtained from one video image, the length of the segment is set up to the frame-per-second of the video (e.g., 30 for the example evaluations described herein) such that the vehicle will move for one second on that segment.

Second, processing circuitry 199 may assume that the vehicle will maintain its speed and acceleration during this one-second window. In such examples, processing circuitry 199 fits a quadratic curve on this segment to compute the speed and acceleration. The computed speed and acceleration are assigned only to the center point of the window.

Third, processing circuitry 199 slides the window and repeats this step for each location point on the trajectory. After that, processing circuitry 199 may save the smoothed speed 405 and smoothed acceleration 410 together with the trajectory so that they can be used for metrics calculation.

In examples where the method lacks consideration of the dynamic properties of vehicles (e.g., the speed cannot be constant if the acceleration is non-zero in the window), the method nevertheless performs sufficiently well with the data available since the vehicles generally do not abruptly accelerate or decelerate within a short period in the traffic scenes observed. However, because of the sliding window, the computed speed may be skewed slightly when the vehicles start to move or brake hard in the intersection scenes, which may cause the calculated safety metrics to be biased. The model may be extended to account for such bias depending upon the extent of the influence. For instance, processing circuitry may be configured to implement better trajectory smoothing algorithms for use with the described CAROM Air framework 275.

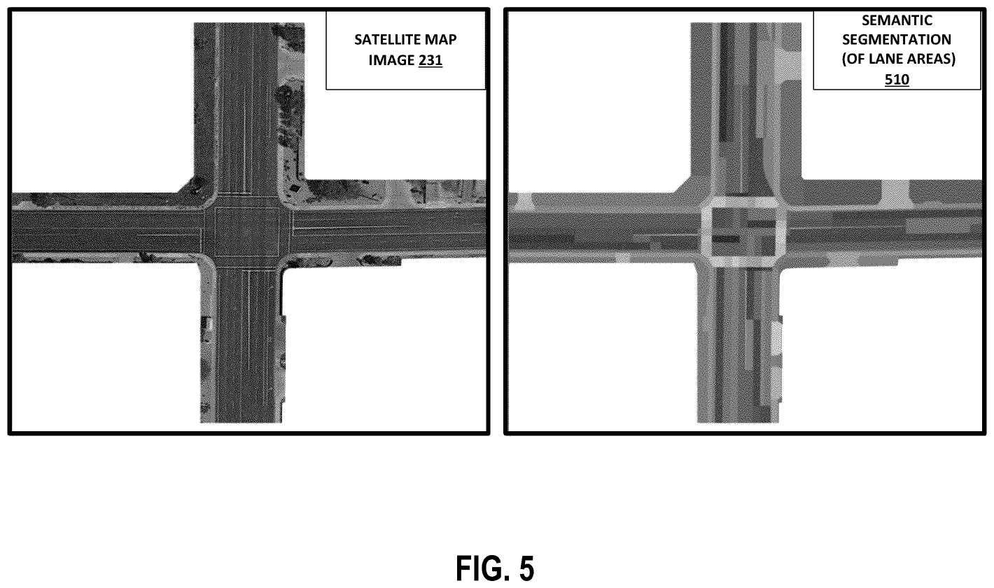

FIG. 5 depicts example maps of intersection scenes from a satellite image 505 (left) and semantic segmentation 510 to lane areas (right), in accordance with aspects of the disclosure.

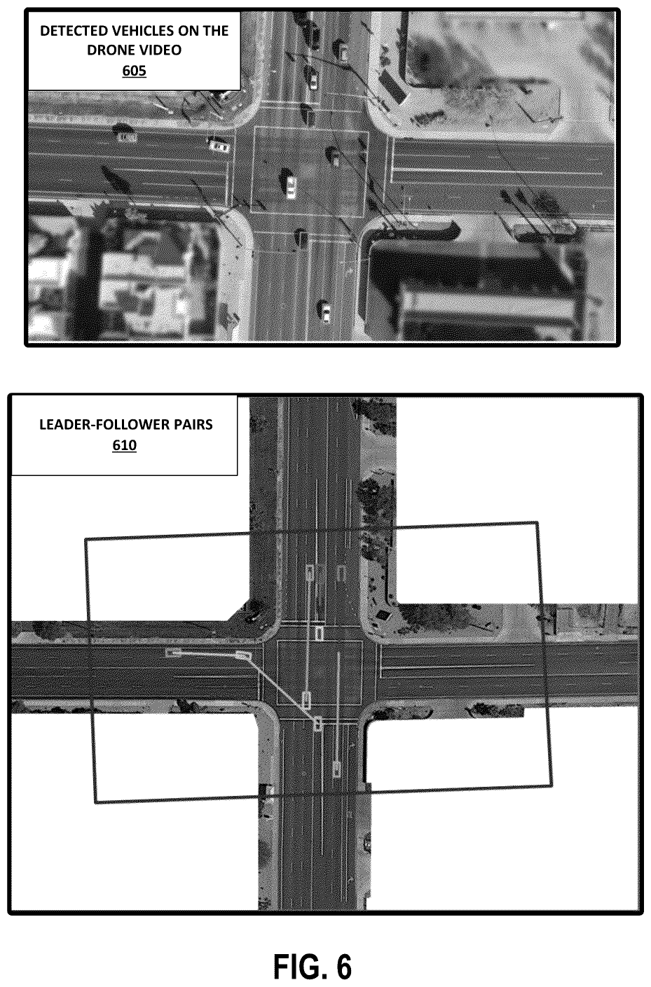

FIG. 6 depicts an example of identified leader-follower vehicle pairs, in accordance with aspects of the disclosure.

### Automated Leader-Follower Identification

When calculating safety metrics within an interaction scenario, processing circuitry may determine the vehicle pairs engaged in interactions that impact each other's decisions. To extract leader-follower pairs from vehicle trajectories, processing circuitry 199 detects such pairs from input data 205 and satellite map image 231 automatically. Different from prior works with one or a few limited scenes, processing circuitry 199 may be extended to execute a method that works for any scene.

In at least one example, processing includes at least the four following operations:

With reference to FIG. 5, first, processing circuitry 199 manually segments satellite map image 231 into areas. Each area is assigned a unique area ID to facilitate the next operation. An example of the semantic segmentation 510 of satellite map image 231 is depicted on the right side of FIG. 5. These segments generally follow the lane markers and traffic rules. The area resembles the “lanelet” concept used in high-definition maps for road traffic simulation and autonomous driving algorithm development. Processing circuitry may utilize only those areas without vectorized lane boundaries and further complicated annotation of traffic rules. Hence, the segmentation is conducted on the 2D satellite map instead of the 3D point cloud map, and segmenting a map costs about one hour of computation time for the example system utilized for the evaluation, which was less expensive than constructing high-definition maps for autonomous driving.

For each scene, satellite map image 231 only needs to be segmented into its corresponding semantic segmentation 510 once, regardless of the amount of source input 205 video data. Furthermore, semantic segmentation 510 within the segmented map is also useful for other tasks, such as detecting safety-critical traffic incidents or traffic rule violations.

Second, processing circuitry 199 may convert each trajectory to a sequence of areas passed by that trajectory, which enables processing circuitry 199 to combine those trajectories that pass the same area sequence into sets. If two vehicles traverse the same sequence of areas, potentially, they may form leader-follower pairs. Moreover, if two trajectories overlap for a subsequence of areas, these two vehicles may also form leader-follower pairs on the overlapped part. These overlapped trajectory segments are also combined into sets.

These sets of trajectories that pass the same area sequence may be constructed on the fly for every pair of vehicles that appear on the same video image. In such examples where processing circuitry converts each vehicle trajectory to a string of traversed area IDs, these sets can be efficiently computed using a substring algorithm.

Third, processing circuitry 199 utilizes the trajectory sets and trajectory segment sets from the previous step to determine the “lane mates” for each vehicle in every video image. For a given vehicle A in an image, processing circuitry 199 may identify another vehicle B on the same image that meets three conditions to be considered a “lane mate” of A. The first condition checks if A and B are in the same “lane”, and there are two potential results of such cases. On the one hand, if both vehicles' trajectories are in the same trajectory set, then they satisfy this condition. On the other hand, if their trajectories are not in the same set, processing circuitry 199 may check if they have an overlapping segment and if they are on the same overlapped trajectory segment. If both checks pass, the first condition is also satisfied. The second condition assesses how much B deviates from A′s trajectory. Processing circuitry 199 may find the closest point of B′s current position on A′s trajectory and consider it acceptable if the distance is less than a set threshold (e.g., satisfies a 2 meters threshold according to the example implementation). A third condition is the reverse of the second: Vehicle A should not deviate too much from vehicle B′s trajectory, which is again computed similarly.

With reference to FIG. 6, fourth, given any vehicle A on a video image, once all “lane mates” of vehicle A that satisfy all these three conditions have been obtained, processing circuitry projects the current positions of those “lane mates” onto the trajectory of vehicle A using the closest point computed in the second condition of the previous step. This operation enables processing circuitry 199 to convert the two-dimensional locations of other vehicles on a map to one-dimensional offsets on the trajectory of vehicle A. These offsets are relative to the current position of vehicle A, and hence, they can be sorted easily.

Finally, the “lane mate” vehicle within detected vehicles on the drone video 605 which exhibits the smallest positive offset is identified as the leader of vehicle A. Refer to identified leader-follower pairs 610 of vehicles depicted at FIG. 6.

Pair Filtering: Despite use of the automated leader-follower pairs 610 identification algorithm, it's important to acknowledge that complex vehicle configurations can pose unique challenges for automated identification algorithms, making data filtering and manual verification beneficial to maintaining the precision of leader-follower pair 610 identification. The data filtering is mostly beneficial in two distinct cases, known errors (e.g., ground truth determined errors) and trailer errors.

Known leader-follower pair 610 errors: First, to correct any known misidentifications in situations where a vehicle is not tracked accurately due to various factors, mainly failures in the neural network vehicle detector and sensor limitations (e.g., overexposure). Such known errors may be fed (e.g., input) back into the neural network for incorporation and updating of the model via reinforcement learning to generate a new improved model variant. For the evaluation, every video was processed, from which a list of wrongly tracked vehicles was generated, which was then utilized to filter out vehicle pairs. Given the 3-hour videos at 12 scenes, approximately 6% of detected vehicles were filtered due to various tracking issues.

Leader-follower pair 610 trailer errors: The second case that warrants extra processing pertains to vehicles with trailers to avoid wrongly considering a truck with a trailer as an erroneously identified leader-follower pair 610 of vehicles. For cases involving trailers, processing circuitry may execute an algorithm to systematically detect and filter out trailers utilizing the following three operations:

First, processing circuitry 199 specifically annotates hundreds of video images with trailers to train the neural network vehicle detector so that the trained neural network has the capability to generate a type code for each vehicle instance, including the trailer as one type. Second, for a leader-follower pair 610 identified in the previous step, if the follower vehicle is detected as a trailer and the distance between the pair of vehicles is less than a threshold distance, then the leader-follower pair 610 is filtered. In the described implementation, the threshold is set to the maximum of the leader and follower vehicle lengths. Third, processing circuitry 199 processes (e.g., consumes) the video and verifies the detected trailers utilizing the trained model variant. In the example evaluation, all trailers on the videos were correctly detected. However, a few trucks were wrongly detected as trailers. Finally, the filtered data is used for metrics calculation and analysis.

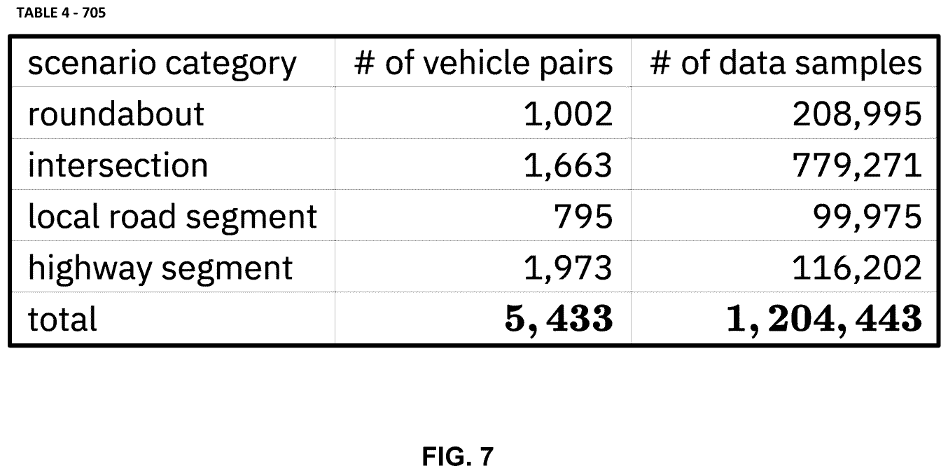

FIG. 7 illustrates Table 4 at element 705 which provides Statistics of vehicle pairs and the number of data samples, in accordance with aspects of the disclosure.

Vehicle Pair Statistics: Table 4 provides the statistical analysis of the identified vehicle leader-follower pairs 610 dataset. Properties such as vehicle velocity and headway distance between these pairs are considered. Understanding the statistical characteristics of vehicle pairs facilitates gaining insights into driving behaviors and safety in car-following scenarios. With the 3-hour drone video dataset, in total, 5,433 vehicle pairs are identified after filtering and manual verification. Most leader-follower pairs 610 last for at least a few seconds when they pass the covered area of the drone camera. Hence, for each drone video image, processing circuitry 199 may obtain one data sample of the vehicle leader-follower pair 610. In total, about 1.2 million data samples were obtained. Table 4 (705) lists the number of vehicle pairs and the number of data samples for each scenario category.

Nomenclature: Note that the term “pair” is utilized to denote “a data sample of a leader-follower vehicle pair.” To balance the dataset, three roundabout sites with relatively heavy traffic were selected and recorded during rush hours to create input data 205 source video. This input data 205 enabled processing circuitry 199 to obtain a sufficient number of vehicle pairs for driving safety metrics analysis. Normally, a roundabout will not be as busy as those in the dataset. For the same reason, processing circuitry 199 selected an intersection and two highway segments with moderate traffic load. Among all the four traffic scenario categories, the local road segments have the least number of vehicle pairs, partially because the road segments are inherently not designed for heavy traffic load and partially because the headway distance between two vehicles is relatively large under light traffic load such that many pairs are not within the coverage of the drone camera.

However, for the intersections, since many pairs of vehicles will stop to wait for the traffic light at the inbound buffer zone of intersections, they will be captured for long periods of time, with a significant number of data samples generated. For many of the data samples under this situation, both the leader vehicle and the follower vehicle are stopped, and the data samples do not carry much information for metrics analysis.

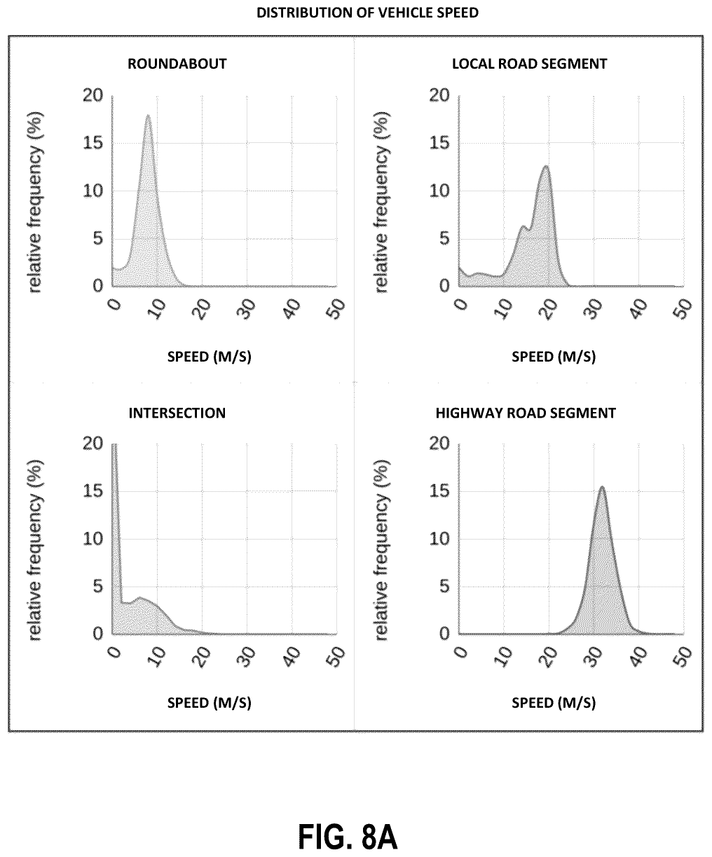

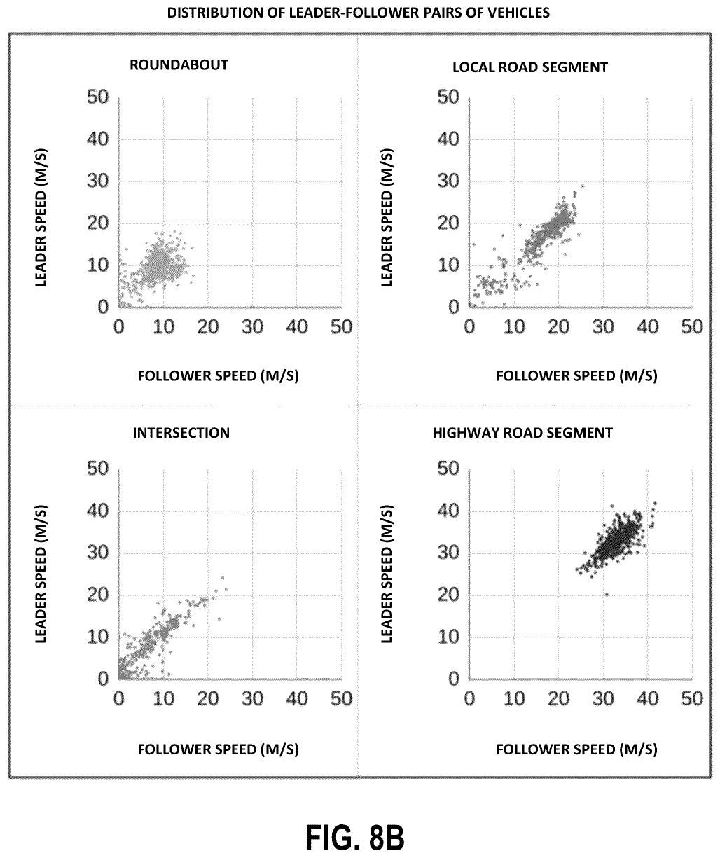

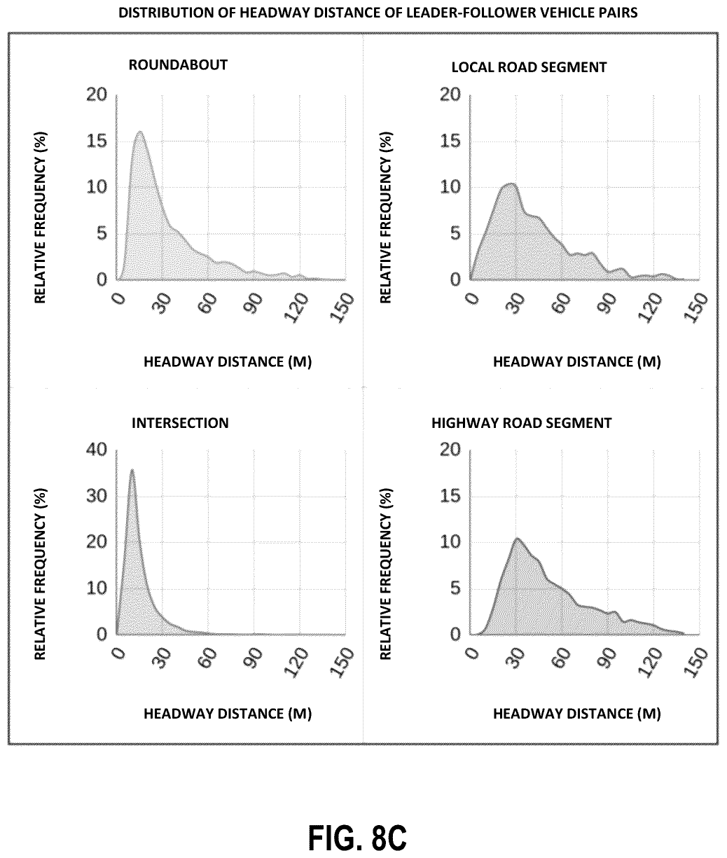

FIGS. 8A, 8B, and 8C depict graphs showing distribution of vehicle speed, distribution of speed of leader-follower vehicle pairs, distribution of headway distance of leader-follower vehicle pairs, and distribution of Minimum Distance Safety Envelope (MDSE), in accordance with aspects of the disclosure.

In FIG. 8A, vehicle speed distributions are depicted for the four scenario categories, including roundabouts, intersections, local road segments and highway road segments. Vehicle speeds exhibit notable variations across diverse scenarios, with higher velocities typically observed on highway segments, while lower speeds are common in the other three scenarios, reflecting the complex dynamics of each environment.

FIG. 8B depicts the speed distribution of leader-follower pairs 610 of vehicles. To construct each subplot of this FIG. 8B, processing circuitry 199 randomly sampled 200 pairs from each scene. In total, for each scenario category with three scenes, there are 600 sampled leader-follower pairs 610 of vehicles. In the majority of cases, leader-follower vehicle pairs tend to exhibit similar speed changes, with the follower's speed closely tracking that of the leader; however, in specific scenarios like roundabouts and intersections, vehicles may slow down upon entering and accelerate upon exiting, resulting in a discernible lag between the follower's speed and the leader's speed, which can be observed in the lower left corner of the plot. The average absolute speed differences for the four scenario categories, e.g., roundabout, intersection, local road segment, and highway segment, are 2.45 m/s, 1.27 m/s, 1.47 m/s, and 1.48 m/s, respectively. Fully 90% of vehicle pairs' speed difference is less than 5 m/s.

FIG. 8C depicts the distribution of the headway distance of leader-follower vehicle pairs. The headway distance is measured as the difference of position offset along the trajectory of the follower vehicle instead of Euclidean distance in the 3D space, which is important for trajectories that are not straight. Headway distances between leader-follower pairs 610 of vehicles vary across scenarios. Headway distances are generally shorter in high-density environments like intersections and roundabouts but longer on local road segments and highways, reflecting the impact of traffic conditions on the spacing between vehicles. The average headway distance of vehicle pairs for the four scenario categories, e.g., roundabout, intersection, local road segment, and highway segment, are 33 m, 15 m, 41 m, and 52 m, respectively. However, as the maximum coverage of the drone camera is about 145 m to 160 m on the diagonal line of the video image, depending on the drone's flying height (typically at 110 m to 120 m), any headway distance larger than the coverage will not be considered in the data analysis.

The headway distance between leader-follower vehicle pairs is influenced by a multitude of dynamic factors. These include the speed of the vehicles, traffic density, driver behavior, road geometry, and environmental conditions. In high-density traffic or congested environments, headway distances tend to be shorter due to the need for closer following to maintain traffic flow. Conversely, on open highways or roads with lower traffic volumes, headway distances often increase. Driver aggressiveness, visibility, and reaction times also play a role in shaping these distances, as do road features such as curves, intersections, and obstacles. Weather conditions such as rain or fog can further impact headway distances by necessitating greater spacing for safety.

These complex interactions highlight the dynamic nature of headway distances in real-world driving scenarios, making their analysis helpful to understanding traffic behavior and enhancing road safety. By examining the distribution and trends in vehicle velocity and headway distance, valuable information may be uncovered about how vehicles interact and influence each other's movements on the road, shedding light on the dynamics of traffic flow and safety considerations.

### Analysis of Longitudinal Safety Envelope

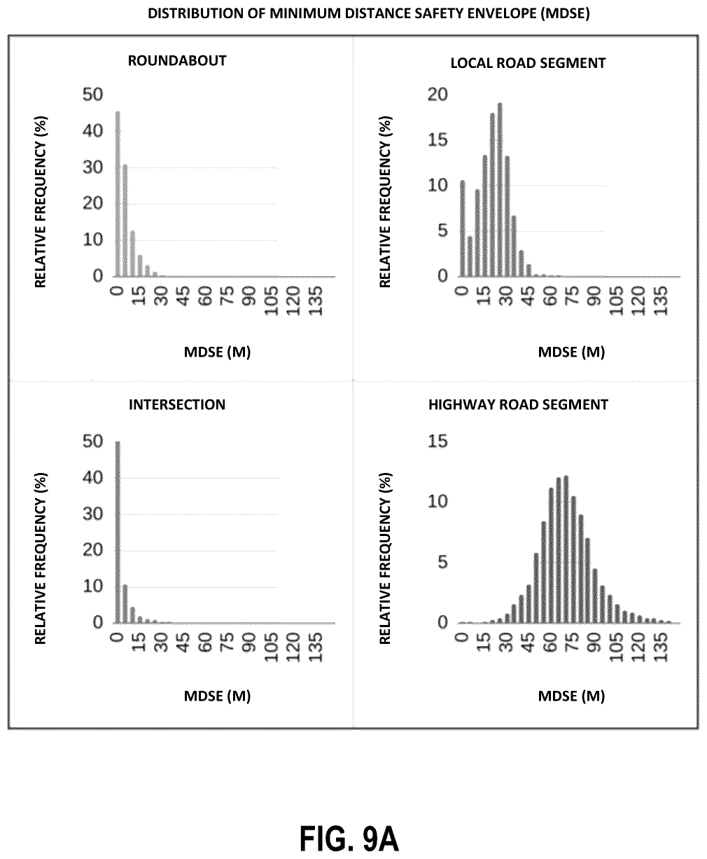

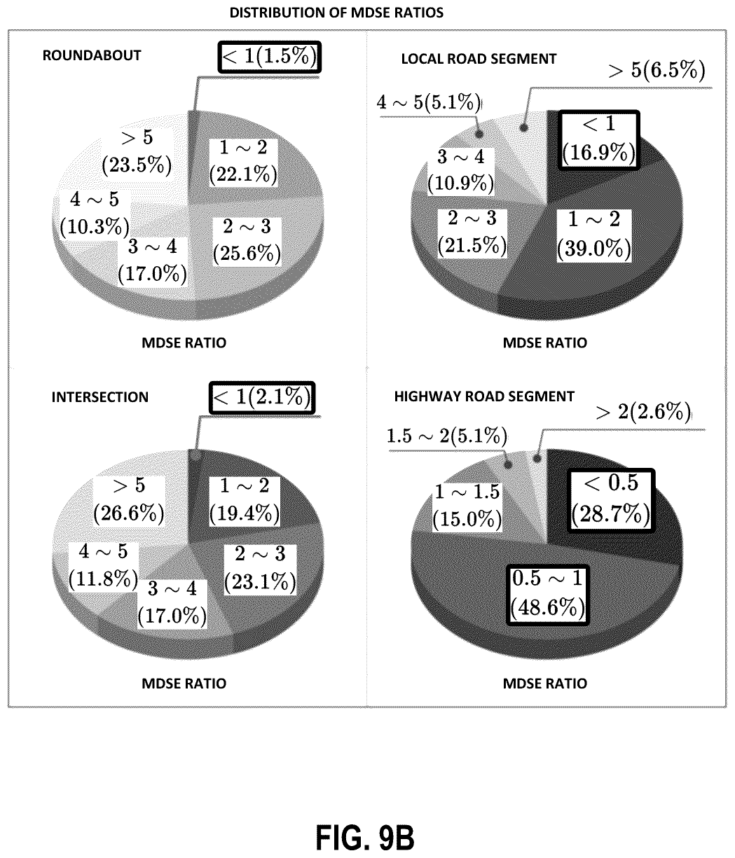

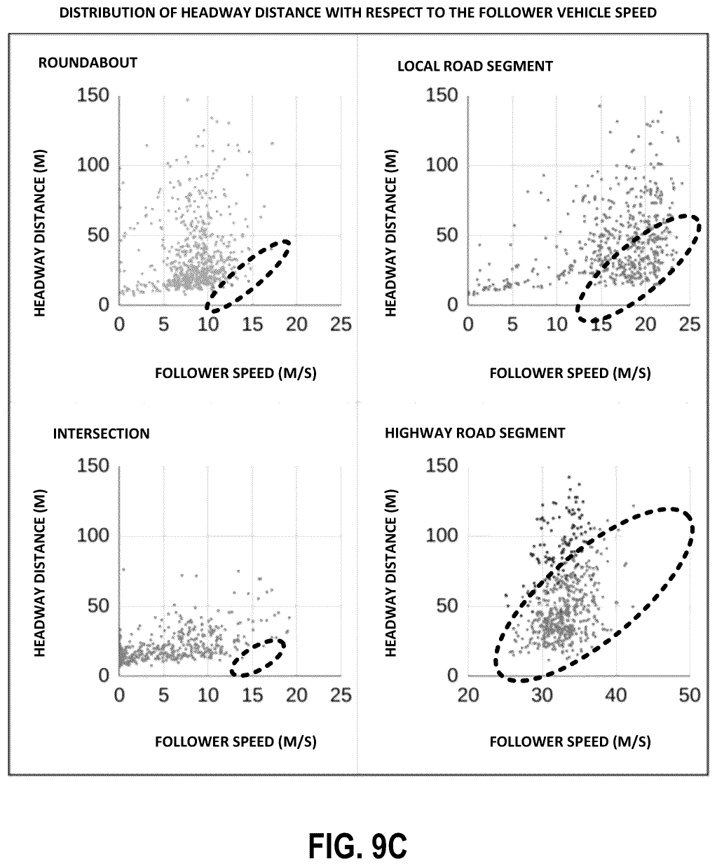

FIG. 9A depicts graphs showing distribution of Minimum Distance Safety Envelope (MDSE), in accordance with aspects of the disclosure.

FIG. 9B depicts graphs showing distribution of MDSE ratios, in accordance with aspects of the disclosure.

FIG. 9C depicts graphs showing distribution of headway distance with respect to the follower vehicle speed, in accordance with aspects of the disclosure.

Processing circuitry 199 may compute and analyze the longitudinal safety metrics. The Minimum Distance Safety Envelope (MDSE) which is a helpful metric for evaluating driving safety, particularly in the context of leader-follower vehicle pairs during sudden braking scenarios. This safety envelope encompasses three components: first, the distance traveled by the follower during their response time; second, the braking distance of the follower; and third, the braking distance of the leader.

Formally, it is defined as follows:

$$MDSE = {[ {v}_{F} ρ + \frac{1}{2} {a}_{F} {ρ}^{2} + \frac{{( {v}_{F} + ρ {a}_{F} )}^{2}}{2 {b}_{F}} - \frac{{( {v}_{L} )}^{2}}{2 {b}_{L}} ]}_{+}$$

where the terms v_{F} and v_{L} are the longitudinal speeds of the follower vehicle and the leader vehicle, respectively. In the analysis, processing circuitry 199 assumes that vehicles do not slip sideways, and hence, v_{F} and v_{L} are the vehicle speeds derived from the trajectory smoothing step. The term a_{F} is the longitudinal acceleration capability of the follower vehicle, which is set to 1.8 m/s². The terms b_{F} and b_{L} denote the longitudinal deceleration capability of the follower and leader vehicles, which are set to 3.6 m/s² and 6.1 m/s². The term ρ is the response time of the follower vehicle, which is set to 0.2 seconds. The values of a_{F}, b_{F}, b_{L}, and ρ are set up following prior work, e.g., with the calibration utilizing a naturalistic driving study (NDS).

MDSE metrics may be implemented to measure the occurrence of a behavior and/or event with a given spatio-temporal safety envelope formulation. These formulations are helpful to identify potential hazardous driving conditions and play an important role in ensuring the safety and reliability of transportation networks. MDSE metrics may also help to define the time and space the subject vehicle has for performing maneuvers and responding to actions of nearby objects, with the aim of reducing the risk of a collision occurring.

The unique characteristics of various driving scenarios, including roundabouts, intersections, local road segments, and highway segments, introduce significant variations in the dimensions of this safety envelope. Distribution of computed MDSE is depicted in FIG. 9 is provided for each of four scenario categories. In environments like roundabouts and intersections, where vehicles may need to decelerate abruptly, the MDSE tends to be relatively compact, reflecting the need for quick and precise responses. This is further depicted in FIG. 9B which provides the distribution of MDSE ratios.

In road segments characterized by intersections and roundabouts, there is a notable bias among manual vehicle operators to exhibit a heightened frequency of speed reduction occurrences. In contrast, road segments such as highways and local roads tend to consistently maintain frequencies of elevated speeds that adhere to prescribed limit ranges. This reflects the nuanced driving behavior and speed dynamics of distinct road infrastructure. However, since the vehicle speed is relatively low in these two scenarios, as shown in FIG. 8A, vehicle pairs generally maintain their headway distance larger than the MDSE, which can be seen by comparing FIGS. 8C and 9A.

Conversely, on local road segments and highways, where traffic flow is typically more stable, the safety envelope tends to be more extensive, allowing for greater reaction time and braking distance due to the larger vehicle speed. Understanding these variations facilitates enhancing driving safety and developing effective safety measures tailored to specific scenarios.

MDSE violations are depicted in bold outlined boxes at FIG. 9B. An MDSE violation occurs when the computed MDSE is less than the instantaneous headway distance between the leader vehicle and the follower vehicle. To better capture the relation between MDSE and the headway distance, processing circuitry 199 computes the MDSE ratio, which is formally defined as the ratio of the headway distance to the calculated MDSE between the follower vehicle and the leader vehicle.

Formally, it is defined as follows:

$$MDSE ratio = \frac{headway distance}{MDSE}$$

where MDSE violations are simply referenced by the vehicle pairs with an MDSE ratio of less than one. Within the distribution of the MDSE ratios for each of the four scenario categories, the MDSE violation parts are depicted in bold outlined boxes. The substantial disparity in MDSE violations among different scenario categories may be observed. In particular, the remarkably high percentage of MDSE violations on highway segments, reaching 77.4%, is a cause for concern. On the one hand, this statistic suggests a heightened risk of safety breaches in scenarios characterized by high-speed travel and potentially reduced reaction times. Based on analysis, one may speculate that the 0.2-second response time is relatively short for high-speed scenarios since the general suggestion of headway time should be at least one to two seconds when driving on the highway so as to leave enough response time.

However, even if the response time is set to one second, fully 38% of vehicle pairs continue to exhibit MDSE violations under the highway segment scenario. The elevated MDSE violations on highway segments emphasize the need for enhanced safety measures and increased awareness of the unique challenges presented by these scenarios. Conversely, the lower percentages of MDSE violations in roundabouts, intersections, and local road segments, at 1.5%, 2.1%, and 16.9%, respectively, indicate relatively more favorable safety conditions in these environments.

These findings underscore the importance of tailoring safety interventions and policies to address the specific safety dynamics in different types of road scenarios, with a particular focus on mitigating the pronounced MDSE violations on highway segments to enhance driving safety.

With reference to FIG. 9C, distributions of headway distance relative to the follower vehicle speeds are depicted, with the MDSE violations highlighted via the bold dotted-line ellipses. It is evident from the distributions of FIG. 9C that the violations tend to occur when follower vehicles are traveling at relatively higher speeds while failing to maintain a sufficient headway distance from the leader vehicle. Particularly, the violations are more frequent when the follower vehicle's speed is larger than 15 m/s. This trend observed in this data aligns with established principles of safe driving, emphasizing the importance of maintaining a suitable buffer between vehicles, especially at higher speeds. In addition, the MDSE ratio reveals the extent to which followers exhibit elevated speeds and reduced headway distances, which further indicates that the MDSE ratio can serve as a clear reminder of the heightened risk associated with tailgating and insufficient spacing between vehicles, particularly when driving at higher speeds on the road, to mitigate the potential for rear-end collisions and enhance overall road safety.

### Analysis of Time-Based Longitudinal Metrics

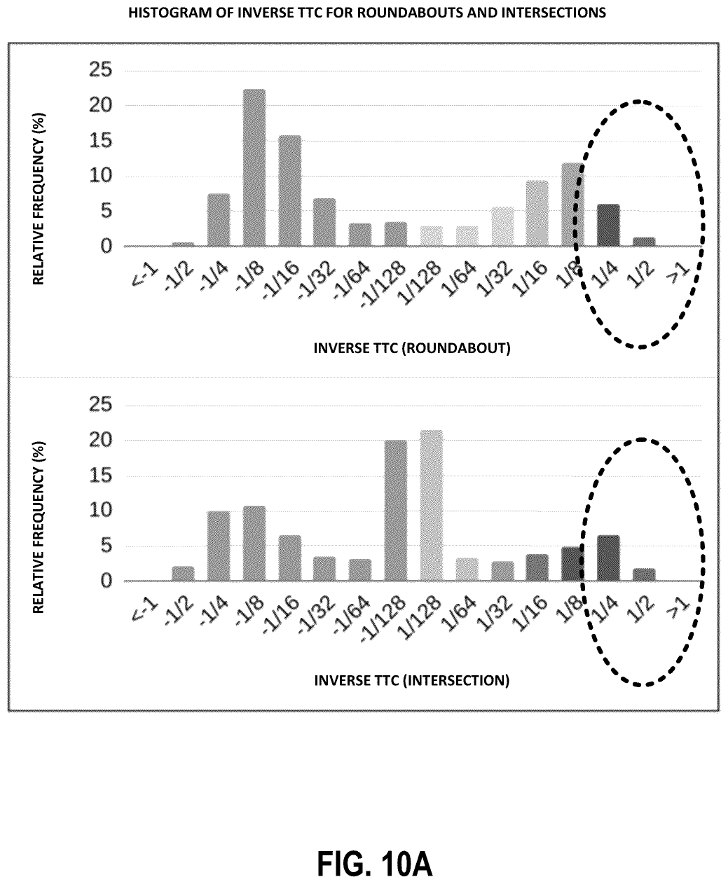

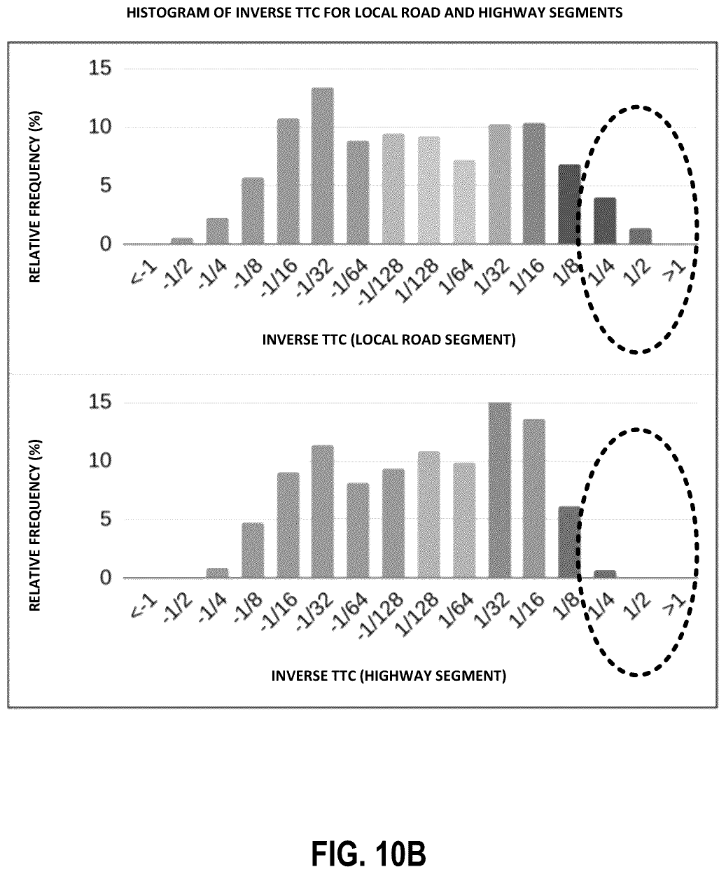

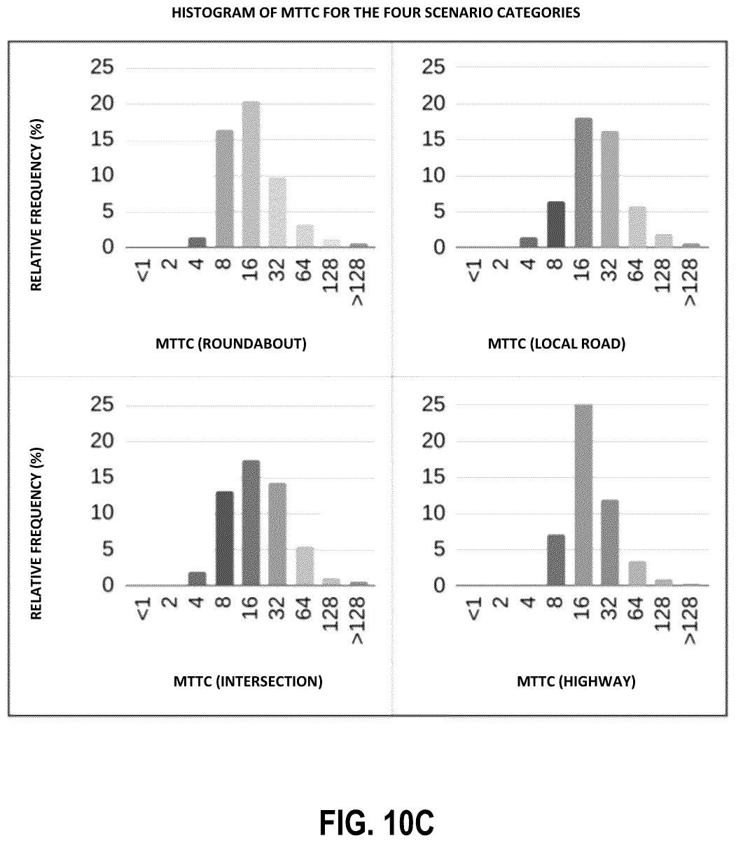

FIG. 10A depicts graphs showing histograms of inverse TTC for roundabouts and intersections, in accordance with aspects of the disclosure.

FIG. 10B depicts graphs showing histograms of inverse TTC for local road and highway segments, in accordance with aspects of the disclosure.

FIG. 10C depicts graphs showing histograms of MTTC for the four scenario categories, in accordance with aspects of the disclosure.

More particularly, two longitudinal safety metrics are examined based on time, e.g., Time-To-Collision (TTC) and Modified Time-To-Collision (MTTC). These two metrics are typically categorized as traditional Surrogate Safety Measures (SSMs), which offer an alternative to accident-based indicators. SSMs are valuable tools used in road safety analyses to quantitatively assess various hazardous traffic situations. Time-To-Collision is defined as the time of collision between two entities in a given scenario in which both entities continue with present velocities in the current environment in the same direction.

Formally, it is defined according to the following equation:

$$TTC = \frac{{X}_{L} - {X}_{F}}{{v}_{F} - {v}_{L}} .$$

where the variables needed to calculate Time-To-Collision are relative positions (e.g., X_{L}−X_{F}), and speed between the two vehicles (e.g., v_{F}−v_{L}).

Although Time-To-Collision was originally defined only for vehicles traveling in a straight line, processing circuitry extends the Time-To-Collision computations so that the relative positions X_{L} and X_{F} are the offsets on the trajectory of the follower vehicle, even when the trajectory is not straight but following a curved lane. Moreover, the Time-To-Collision formulation only considers the speed at which the subject vehicles are traveling, implicitly assuming that the response time and acceleration of both objects are zero. Hence, it can have negative values if the speed of the leader vehicle is larger than the speed of the follower vehicles, and it can even be infinite if the two vehicles have the same speed.

For the convenience of analysis, the histograms of FIGS. 10A and 10B provides the inverse of Time-To-Collision rather than Time-To-Collision (non-inversed). The histogram bins are intentionally selected at log scale to better capture the portion of vehicle pairs with Time-To-Collision in different ranges. From each of FIGS. 10A and 10B, a few insights may be attained.

First, although the speed of the leader vehicle and the follower vehicle are generally in the same range with slight variance, as shown in FIG. 8B, the Time-To-Collision metric can capture the details of the variance. This also means that the vehicle speed measurements need to be precise. While this is generally not an issue for the drone videos, for a system on the roadside or on the road infrastructure, it might be challenging, and slight sensor noise may cause large fluctuation of Time-To-Collision, especially when the speeds of the vehicle pairs are close.

Second, the inverse Time-To-Collision plots seem symmetric, which indicates that the speed variance of the vehicle pairs may not be able to capture the driver's intent. Hence, even statistical results of Time-To-Collision can show how dangerous the traffic is, but it is difficult to interpret why it is dangerous with temporal analysis of the change of Time-To-Collision.

Third, given the dataset, for the four scenario categories, e.g., roundabout, intersection, local road segment, and highway segment, the percentage of vehicle pairs with a Time-To-Collision less than four seconds is 5.8%, 6.4%, 1.0%, and 0.5%, respectively. These are also highlighted via the bold dotted-line ellipses in each of FIGS. 10A and 10B.

Evaluations confirm that for both roundabouts and intersections, the cause of these small Time-To-Collision values is pairs of vehicles entering the roundabouts or the intersections, e.g., the delayed deceleration of the follower vehicle with respect to the leader vehicle. Although it seems like these small Time-To-Collision values indicate higher chances of tailgate collision, it is counterintuitive that the low-speed scenarios generate more small Time-To-Collision values than the high-speed scenarios. As a result, it might not be appropriate to directly compare the percentage of Time-To-Collision violations or the extent of Time-To-Collision violations among different scenarios. Instead, a calibration from a naturalistic driving dataset might be needed to interpret Time-To-Collision results.

As Time-To-Collision only considers velocity, Modified Time-To-Collision (MTTC or Modified TTC) introduces enhancements to traditional collision risk assessment by considering an additional factor, e.g., the relative acceleration. Formally, defined according to the equation, as follows:

$$MTTC = \frac{- Δ \overline{V} \pm \sqrt{{\overline{V}}^{2} + 2 Δ \overline{A} D}}{Δ \overline{A}}$$

where the term ΔV̅ is the relative speed (e.g., v_{F}−v_{L}); where the term D is the headway distance (e.g., X_{L}−X_{F}); where the term ΔĀ is the relative acceleration (e.g., a_{F}−a_{L}) which is not considered in Time-To-Collision.

By considering relative acceleration, Modified Time-To-Collision provides a more comprehensive evaluation of safety in traffic situations.

With reference to FIG. 10C, the histogram of calculated Modified Time-To-Collision for the four scenario categories is provided. Given the dataset, for the four scenario categories, e.g., roundabout, intersection, local road segment, and highway segment, the percentage of vehicle pairs with a Modified Time-To-Collision less than four seconds is 1.4%, 1.9%, 1.5%, and 0.1%, respectively.

As the results show, in scenarios characterized by abrupt speed changes or complex driver behavior, Modified Time-To-Collision offers a more nuanced perspective on collision risk, making it a valuable tool for capturing the intricacies of real-world traffic dynamics. However, the Modified Time-To-Collision metric shares the same properties as the Time-To-Collision metric. Particularly, the usage of acceleration makes it even more challenging for roadside or road infrastructure-based systems to calculate it in real time with enough accuracy.

### The Carom Air Dataset

FIGS. 11A, 11B and 11C depict all twelve (12) traffic scenes utilized throughout the study, in accordance with aspects of the disclosure. The traffic scenes are grouped into four main categories, corresponding to the four columns in each of FIGS. 11A, 11B and 11C. The names of the scenes follow those in the CAROM Air dataset 250, For each scene, the drone image, the satellite image map 231, and the lane segments are depicted. The satellite maps are obtained from screenshots of Microsoft Bing Maps (for scene DO) or Google Maps (for all other scenes), with editing removing vehicles and shadows.

Using CAROM Air framework 275, drone video was collected as source input 205 and processed from 40 different scenes covering a variety of traffic patterns, including roundabouts, intersections, local road segments, and highway segments. In five scenes, two drones 251 were flown to cover larger areas. The source input 205 videos from the two drones 251 were synchronized. Besides the road traffic metadata, the map was also segmented at the lane level and annotated the type of these segmented areas, e.g., vehicle lanes, curb areas, sidewalks, crosswalks, buffer areas, etc.

The field-of-view of each drone video is also shown on the satellite map image 231 as a quadrilateral, and the triangle of the quadrilateral indicates the top-left corner of the drone video. The lane segments are shaded in different semantic categories, such as curb area, sidewalk, crosswalk, lane, and lane buffer space.

Utilization of artificial intelligence has led to increased popularity of traffic monitoring video-based road traffic safety analysis within academic and research communities. Using the infrastructure-based cameras and the localization described above, kinematics for car-following scenarios were extracted where a pair of vehicles approach or leave a traffic intersection. For ground-based cameras, it is not always possible to extract accurate localization information as these data could have scenarios where one or both vehicles could be occluded. Conversely, utilizing source input 205 video data extracted from captured via drones 251 and extracted from such drone videos, an advantage over ground-based data is realized.

Additionally, time-based and distance-based metrics for car-following scenarios in simulation and for real-world data are available. However, prior techniques emphasize metric violations and their durations to study the robustness and relevance of the proposed metrics. Conversely, the techniques described herein analyze the magnitude distribution of the safety metrics for different scenario categories. Besides cameras on the ground or road infrastructure, naturalistic driving data can also be obtained from onboard sensors, such as the VTTI dataset. However, to study driving safety metrics defined on pairs of leader-follower vehicles, such a naturalistic driving dataset may not be the best option due to the limitation of the data for vehicle pairs.

Instead, a dataset 250 derived from source input 205 drone video provides more samples of vehicle pairs with better diversity. There are also drone 251 datasets available for academic research, notably the LeveXData. Compared to these drone datasets, sampling data from specifically designated traffic scenes facilitates a comparison of the metrics under different scenes in the same city. Hence, a flexible data acquisition method such as that which is described herein may be more valuable than using existing open datasets.

In such a way, a novel dataset 250 is introduced and evaluations were conducted providing an in-depth analysis of driving safety metrics specifically designed for car-following scenarios. The disclosed methodology leverages cutting-edge technology, utilizing drones to capture high-resolution video data from 12 distinct traffic scenes (see FIGS. 11A, 11B, and 11C) in the Phoenix metropolitan area. Advanced Artificial Intelligence (AI) algorithms were employed to extract precise vehicle trajectories, and semantic maps were used to identify leader-follower pair 610 relationships among vehicles.

By incorporating a set of metrics based on prior work on Operational Safety Assessment (OSA) metrics by the Institute of Automated Mobility (IAM), three driving safety metrics (e.g., MDSE, TTC, and MTTC) were analyzed and examined utilizing real-world traffic scenes. The data uncovers the distribution of these metrics and compares them in different scenarios, which provides insights into the impact of various parameters and thresholds on these metrics. From the results obtained for the car-following scenarios, at least the following conclusions may be drawn:

First, time-based metrics like Time-To-Collision or Modified Time-To-Collision rely on accurate measurement of velocities and accelerations of the vehicles, which presents challenges for traffic operators with equipment mounted on the roadside or on the road infrastructure. Instead, they are potentially useful for self-driving vehicles with onboard sensors that directly measure the difference of velocity and acceleration.

Second, Minimum Distance Safety Envelope (MDSE) considers velocity, the capability of acceleration, and the capability of deceleration, response time, and headway distance, which is robust and interpretable. Instead of using a threshold for violation detection, the MDSE ratio may be utilized to capture the severity better. Additionally, different response time and acceleration capability parameters may be utilized under different traffic scenarios (e.g., shorter response time on local roads vs. longer response time on highways). The data-driven approach has the potential to empower traffic operators and policymakers and equip them with valuable information to make informed decisions and enhance the safety and efficiency of future road transportation systems.

Although the dataset does not contain safety-critical incidents such as vehicle tailgate collisions (for general car-following scenarios) or T-bone collisions (for roundabouts), it nevertheless complements prior metrics studies but may lack flexibility. However, CAROM Air framework 275 may be extended to provide a “replay-and-simulation” program with the dataset 250 so that researchers can replay the data in simulation while being able to instrument vehicles and change their behavior. Furthermore, aspects of the disclosure provide answers to questions such as: “How safe is it if the vehicle is 10% faster?”

Due to regulations, the maximum height of the drone is about 120 meters, which leads to limited coverage. This is especially restrictive when studying high-speed scenarios since the headway distance can easily exceed the coverage of the drone. In some examples, data input collection may be extended to fly two drones together and pitch the camera view angle slightly to cover a larger area. Additionally, limited resources available to annotate and train the neural network vehicle detector may limit the dataset 250, and hence, the number of tracking errors is not negligible (about 6% of all vehicle instances). However, CAROM Air framework 275 and the data collection techniques may be extended and scaled utilizing improved AI models and algorithms and improve overall data processing. Still further, the current driving safety metrics are mainly defined on car-following scenarios, which ignores many factors that need to be considered, such as lateral safety margin, pedestrians, and rate of turning. The disclosed methodology may therefore be extended utilizing different fine-grained metrics for different scenarios to better quantify the severity of violation.

### Applications

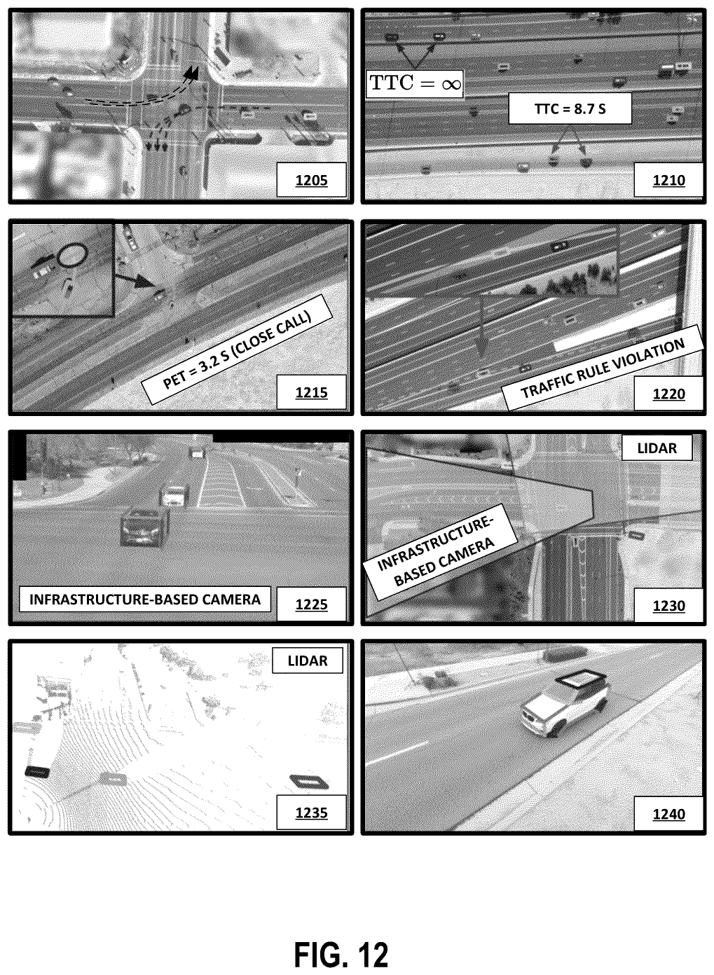

FIG. 12 depicts example applications of CAROM Air framework 275, in accordance with aspects of the disclosure. Here, five different applications enabled by CAROM Air framework 275 are described, including the following:

Fine-grained traffic counting application: Traffic counting and statistical analysis facilitate traffic management in local DOTs. CAROM Air framework 275 automates the counting and analysis process down to the lane level. Utilizing a semantically segmented map, processing circuitry compiles each vehicle's trajectory into a list of map segments traversed by the vehicle. Processing circuitry then counts those vehicles that follow a certain pattern.

For example, block 1205 depicts southbound trajectories via the lower bold dotted lines, from which it may be observed that the percentages of left turning vehicles that leave the intersection in the leftmost lane, middle lane, and the rightmost lane are 45%, 45%, 10%. On the northbound trajectories depicted via the upper bold dotted lines, the percentages are 23%, 55%, and 22%. Similarly, in block 1220, the speed of vehicles on each lane can be obtained using the segmented map, which shows that 54% of the vehicles on the leftmost lane of the highway segment exceed the speed limit.

Road safety analysis application: Various performance assessment metrics have been proposed to objectively evaluate driving safety, which can be calculated from data of vehicle states in the 3D space. For example, block 1210 depicts the disclosed road traffic metadata and segmented map may be utilized by CAROM Air framework 275 to compute the Time-To-Collision (TTC) metric for pairs of adjacent vehicles in the same lane. Similarly, block 1215 depicts that, given those intersecting vehicle trajectories and the area of encroachment, the Post Encroachment Time (PET) metric can be computed by CAROM Air framework 275. Moreover, it is further possible to “re-simulate” the motion of vehicles using dataset 250 utilizing CAROM Air framework 275, and then probe the safety envelope in a simulator by changing the physical properties of the vehicle.

Traffic incident detection application: Studying hours or even hundreds of hours of traffic data is costly and labor intensive. Through the use of CAROM Air framework 275, a program can search through dataset 250 and detect incidents of interest. For example, block 1220 depicts a vehicle driving through an area separating the main lanes on the highway and the ramp, which is a known traffic rule violation. CAROM Air framework 275 can detect incidents of this kind using dataset 250 by determining whether a vehicle is in that area on the segmented map. Similarly, block 1215 depicts a close call incident which CAROM Air framework 275 can detect when the PET is less than a threshold amount. Similarly, CAROM Air framework 275 can detect an aggressive driving incident if the acceleration of a vehicle is higher than a threshold amount.

Reference measurement and labeling application: In order to deploy cameras and LiDARs on road infrastructure to monitor traffic, effective neural network models are needed to detect vehicles. However, constructing labeled datasets to train these models is expensive, especially if labeling vehicle 3D bounding boxes are needed. With accurate cross-sensor calibration, road traffic metadata generated from CAROM Air framework 275 can be used to label the data obtained from other sensors. Dataset 250 can also be used as a reference measurement to evaluate the performance of other traffic monitoring systems. For example, block 1230 depicts vehicle localization results as captured via source input 205 aerial video. The results are projected onto an image obtained from an infrastructure-based camera in block 1225. These results are also shown in the 3D space together with the point cloud obtained from an infrastructure-based LiDAR in block 1235.

Generalization application: CAROM Air framework 275 enables keypoint 215 based vehicle localization which may be further applied to source input 205 video from non-aerial perspectives. Block 1240 depicts such an example. For instance, keypoint 215 detectors may be retrained with source input 205 data from the same perspective (e.g., non-aerial video capture). More robust regularization may be utilized when some keypoints 215 are not observable, such as when a vehicle moves toward the camera or if the vehicle is partially occluded by another vehicle.

In such a way, CAROM Air framework 275 enables keypoint 215 based vehicle localization and traffic scene reconstruction framework using aerial videos recorded by consumer-grade drones 251. CAROM Air framework 275 demonstrably achieved decimeter-level localization accuracy which enables many practical downstream traffic analysis applications. CAROM Air framework 275 may be further extended by addressing external limitations such as flight time constraints, restricted fly zones in cities, potential risks of drone crashes, and limited dynamic range of the drone 251 camera which can induce detector errors vehicles that appear infrequently in the training dataset 250 (e.g., motorcycles, trucks, and trailers, etc. In such a way CAROM Air framework 275 serves as a flexible platform upon which to monitor road traffic and enable improvements to road safety.

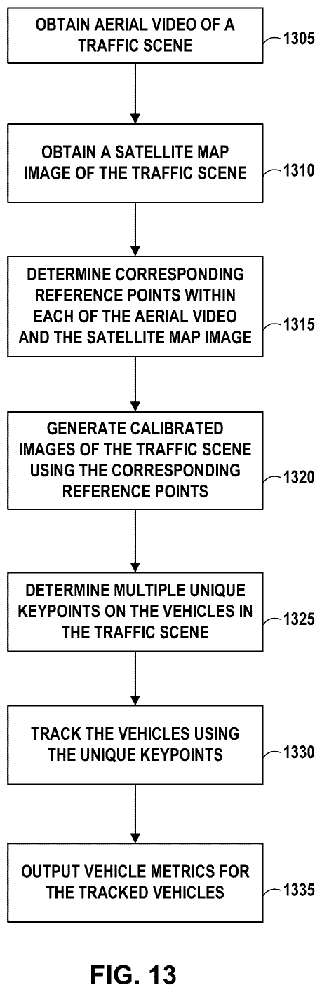

FIG. 13 is a flow chart illustrating an example mode of operation for computing device 100 to implement a CAR-On-Map (“CAROM”) air framework for vehicle localization and traffic scene reconstruction using aerial video, in accordance with aspects of the disclosure. The mode of operation is described with respect to computing device 100 and FIGS. 1-12.

Computing device 100 may obtain aerial video of a traffic scene (1305). For example, processing circuitry 199 of computing device 100 may obtain as source input, aerial video of a traffic scene including vehicles that traverse the traffic scene.

Computing device 100 may obtain a satellite map image of the traffic scene (1310). For example, processing circuitry 199 of computing device 100 may obtain a satellite map image of the traffic scene distinct from any aerial image of the traffic scene within the source input.

Computing device 100 may determine corresponding reference points within each of the aerial video and the satellite map image (1315). For example, processing circuitry 199 of computing device 100 may determine aerial image reference points of the traffic scene present within the source input which correspond to satellite map image reference points of the traffic scene present within the satellite map image of the traffic scene.

Computing device 100 may generate calibrated images of the traffic scene using the corresponding reference points (1320). For example, responsive to determination of the aerial image reference points of the traffic scene present within the source input which correspond to satellite map image reference points of the traffic scene present within the satellite map image of the traffic scene, processing circuitry may generate calibrated images of the traffic scene from individual frames of the aerial video of the traffic scene by calibrating the individual frames of the aerial video with the satellite map image of the traffic scene utilizing the corresponding satellite map image reference points of the traffic scene.

Computing device 100 may determine multiple unique keypoints on the vehicles in the traffic scene (1325). For example, processing circuitry 199 of computing device 100 may determine multiple unique keypoints on the vehicles that traverse the traffic scene.

Computing device 100 may track the vehicles using the unique keypoints (1330). For example, responsive to the determination of the multiple unique keypoints on the vehicles that traverse the traffic scene, processing circuitry 199 of computing device 100 may track the vehicles that traverse the traffic scene across the individual frames of the aerial video utilizing the multiple unique keypoints determined on the vehicles.

Computing device 100 may output vehicle metrics for the tracked vehicles (1335). For example, processing circuitry 199 of computing device 100 may output vehicle metrics for one or more of the vehicles that traverse the traffic scene.

Computing device 100 may execute, via the processing circuitry, a CAR-On-Map (“CAROM”) air framework for vehicle localization and traffic scene reconstruction using the aerial video of the traffic scene.

Computing device 100 may estimate a vehicle state for each of the vehicles that traverse the traffic scene to establish a current position and a heading of each of the vehicles within each of the calibrated images.

Computing device 100 may output the vehicle metrics for at least one of the vehicles that traverse the traffic scene, including one or more of: a vehicle type, a vehicle location, a vehicle speed, a vehicle trajectory, a vehicle traffic violation a vehicle collision incident, a vehicle collision near-incident, a Time-To-Collision (TTC) metric for pairs of adjacent vehicles in a same lane within the traffic scene, or a Post Encroachment Time (PET) metric.

Computing device 100 may calibrate the individual frames of the aerial video with the satellite map image of the traffic scene utilizing the corresponding satellite map image reference points of the traffic scene by applying a Perspective-n-Points algorithm (PnP algorithm) to correct for positional camera drift induced into each of the individual frames of the aerial video by movement of a drone over the traffic scene having recorded the aerial video of the traffic scene.

Computing device 100 may calibrate the individual frames of the aerial video with the satellite map image of the traffic scene utilizing the corresponding satellite map image reference points of the traffic scene.

Computing device 100 may compute, via the processing circuitry, a 3D pose of camera affixed to the drone concurrent with the recording of the aerial video of the traffic scene by the drone.

Computing device 100 may calibrate, via the processing circuitry, the 3D pose of the camera with the corresponding satellite map image reference points of the traffic scene.

Computing device 100 may execute, via the processing circuitry, a keypoint Region-based Convolutional Neural Network model (keypoint RCNN model) to determine the multiple unique keypoints on the vehicles.

Computing device 100 may create, via the keypoint RCNN model, bounding boxes within the calibrated images of the traffic scene encompassing each of the vehicles utilizing the multiple unique keypoints determined for each of the respective vehicles.

Computing device 100 may obtain the source input having the aerial video of the traffic scene via one or more: a low flying aerial platform or a drone.

Computing device 100 may obtain the reference map of the traffic scene via one or more of: a publicly accessible source of satellite imagery containing at least the traffic scene, a subscription-based source of the satellite imagery containing at least the traffic scene, or a publicly accessible Geographic Information System (GIS) source containing at least the traffic scene.

Computing device 100 may compute a velocity of each of the vehicles in the traffic scene using motion derived from a comparison of keypoints within individual frames of the aerial video and a frame rate of the aerial video.

Computing device 100 may execute, via the processing circuitry, a pinhole camera model with no distortion.

Computing device 100 may execute, via the processing circuitry, a flat ground model.

Computing device 100 may obtain as the source input, the aerial video of the traffic scene including the vehicles that traverse the traffic scene from the pinhole camera model and the flat ground model.

Computing device 100 may execute, via the processing circuitry, a vehicle model fitting algorithm to identify specific vehicle models aggregate, via the vehicle model fitting algorithm, collection of publicly available 3D vehicle models.

Computing device 100 may pre-process the aggregated publicly available 3D vehicle models to generate a set of candidate vehicle models having a 1:1 scale corresponding to real-world vehicles.

Computing device 100 may track the vehicles that traverse the traffic scene across the individual frames of the aerial video utilizing the candidate vehicle models.

Computing device 100 may pre-process the aggregated publicly available 3D vehicle models to generate a set of candidate vehicle models by concatenating (x, y, z) coordinates of all of the multiple unique keypoints on the vehicles that traverse the traffic scene onto the set of candidate vehicle models as a shape vector {Sᵢ} when corresponding coordinates are available for each respective vehicle within the set of candidate vehicle models.

Computing device 100 may create bounding boxes within the calibrated images of the traffic scene encompassing each of the vehicles utilizing the multiple unique keypoints determined for each of the respective vehicles.

Computing device 100 may execute, via processing circuitry, Principal Component Analysis (PCA) on each of the candidate vehicle models as the shape vector {Sᵢ} for all candidate vehicle models to determine mean shape sₘ for each of the candidate vehicle models.

Computing device 100 may, for each respective one of the vehicles that traverse the traffic scene, identify a best fit among the candidate vehicle models based on a comparison of the multiple unique keypoints and the bounding boxes created within the calibrated images using the shape vector {Sᵢ} and the mean shape sₘ determined for each of the candidate vehicle models.

Computing device 100 may determine each of the multiple unique keypoints on the vehicles that traverse the traffic scene based on an identifiable vehicle keypoint of each respective one of the vehicles that traverse the traffic scene, wherein each identifiable vehicle keypoint is selected from the group comprising: corner of a vehicle roof top, corner of a vehicle front windshield, corner of a vehicle rear window, center of a vehicle front light, center of a vehicle rear light, center of a vehicle front bumper, center of a vehicle rear bumper, center of a vehicle wheel, corner of a vehicle chassis bottom surface, outermost corner of a vehicle side mirror, corner of a vehicle front door window, wheel-to-ground contact point of a vehicle, or center of a vehicle front brand logo.

Computing device 100 may, subsequent to output of the vehicle metrics for one or more of the vehicles that traverse the traffic scene, output, via the processing circuitry and for display, a simulation of one or more of the vehicles that traverse the traffic scene.

Computing device 100 may receive as input, modifications to physical properties of the one or more of the vehicles that traverse the traffic scene within the simulation. Computing device 100 may, responsive to receipt of the input, the modifications to the physical properties of the one or more of the vehicles that traverse the traffic scene within the simulation, output, via the processing circuitry and for display, a re-simulation of the one or more of the vehicles that traverse the traffic scene using the modifications to the physical properties of the one or more of the vehicles received as input.

For processes, apparatuses, and other examples or illustrations described herein, including in any flowcharts or flow diagrams, certain operations, acts, steps, or events included in any of the techniques described herein can be performed in a different sequence, may be added, merged, or left out altogether (e.g., not all described acts or events are necessary for the practice of the techniques). Moreover, in certain examples, operations, acts, steps, or events may be performed concurrently, e.g., through multi-threaded processing, interrupt processing, or multiple processors, rather than sequentially. Certain operations, acts, steps, or events may be performed automatically even if not specifically identified as being performed automatically. Also, certain operations, acts, steps, or events described as being performed automatically may be alternatively not performed automatically, but rather, such operations, acts, steps, or events may be, in some examples, performed in response to input or another event.

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

In accordance with the examples of this disclosure, the term “or” may be interrupted as “and/or” where context does not dictate otherwise. Additionally, while phrases such as “one or more” or “at least one” or the like may have been used in some instances but not others; those instances where such language was not used may be interpreted to have such a meaning implied where context does not dictate otherwise.

In one or more examples, the functions described may be implemented in hardware, software, firmware, or any combination thereof. If implemented in software, the functions may be stored, as one or more instructions or code, on and/or transmitted over a computer-readable medium and executed by a hardware-based processing unit. Computer-readable media may include computer-readable storage media, which corresponds to a tangible medium such as data storage media, or communication media including any medium that facilitates transfer of a computer program from one place to another (e.g., pursuant to a communication protocol). In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can include RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the terms “processor” or “processing circuitry” as used herein may each refer to any of the foregoing structures or any other structure suitable for implementation of the techniques described. In addition, in some examples, the functionality described may be provided within dedicated hardware and/or software modules. Also, the techniques could be fully implemented in one or more circuits or logic elements.

What is claimed is:

1. A system comprising:
processing circuitry; and
non-transitory computer readable media storing instructions that, when executed by the processing circuitry, configure the processing circuitry to:
obtain as source input, aerial video of a traffic scene including vehicles that traverse the traffic scene;
obtain a satellite map image of the traffic scene distinct from any aerial image of the traffic scene within the source input;
determine aerial image reference points of the traffic scene present within the source input which correspond to satellite map image reference points of the traffic scene present within the satellite map image of the traffic scene;
responsive to determination of the aerial image reference points of the traffic scene present within the source input which correspond to satellite map image reference points of the traffic scene present within the satellite map image of the traffic scene, generate calibrated images of the traffic scene from individual frames of the aerial video of the traffic scene by calibrating the individual frames of the aerial video with the satellite map image of the traffic scene utilizing the corresponding satellite map image reference points of the traffic scene;
determine multiple unique keypoints on the vehicles that traverse the traffic scene;
responsive to the determination of the multiple unique keypoints on the vehicles that traverse the traffic scene, track the vehicles that traverse the traffic scene across the individual frames of the aerial video utilizing the multiple unique keypoints determined on the vehicles; and
output vehicle metrics for one or more of the vehicles that traverse the traffic scene.

2. The system of claim 1, wherein the processing circuitry is further configured to:
execute, via the processing circuitry, a CAR-OnMap (“CAROM”) air framework for vehicle localization and traffic scene reconstruction using the aerial video of the traffic scene.

3. The system of claim 1, wherein the processing circuitry is further configured to:
estimate a vehicle state for each of the vehicles that traverse the traffic scene to establish a current position and a heading of each of the vehicles within each of the calibrated images.

4. The system of claim 1, wherein the processing circuitry is further configured to:
output the vehicle metrics for at least one of the vehicles that traverse the traffic scene, including one or more of:
a vehicle type;
a vehicle location;
a vehicle speed;
a vehicle trajectory;
a vehicle traffic violation
a vehicle collision incident;
a vehicle collision near-incident;
a Time-To-Collision (TTC) metric for pairs of adjacent vehicles in a same lane within the traffic scene; or
a Post Encroachment Time (PET) metric.

5. The system of claim 1, wherein the processing circuitry is further configured to:
calibrate the individual frames of the aerial video with the satellite map image of the traffic scene utilizing the corresponding satellite map image reference points of the traffic scene by applying a Perspective-n-Points algorithm (PnP algorithm) to correct for positional camera drift induced into each of the individual frames of the aerial video by movement of a drone over the traffic scene having recorded the aerial video of the traffic scene.

6. The system of claim 5, wherein the processing circuitry is further configured to:
calibrate the individual frames of the aerial video with the satellite map image of the traffic scene utilizing the corresponding satellite map image reference points of the traffic scene by processing circuitry further configured to:
compute, via the processing circuitry, a 3D pose of camera affixed to the drone concurrent with the recording of the aerial video of the traffic scene by the drone; and
calibrate, via the processing circuitry, the 3D pose of the camera with the corresponding satellite map image reference points of the traffic scene.

7. The system of claim 1, wherein the processing circuitry is further configured to:
execute, via the processing circuitry, a keypoint Region-based Convolutional Neural Network model (keypoint RCNN model) to determine the multiple unique keypoints on the vehicles; and
create, via the keypoint RCNN model, bounding boxes within the calibrated images of the traffic scene encompassing each of the vehicles utilizing the multiple unique keypoints determined for each of the respective vehicles.

8. The system of claim 1, wherein the processing circuitry is further configured to:
obtain the source input having the aerial video of the traffic scene via one or more:
a low flying aerial platform; or
a drone.

9. The system of claim 1, wherein the processing circuitry is further configured to:
obtain the reference map of the traffic scene via one or more of:
a publicly accessible source of satellite imagery containing at least the traffic scene;
a subscription-based source of the satellite imagery containing at least the traffic scene; and
a publicly accessible Geographic Information System (GIS) source containing at least the traffic scene.

10. The system of claim 1, wherein the processing circuitry is further configured to:
compute a velocity of each of the vehicles in the traffic scene using motion derived from a comparison of keypoints within individual frames of the aerial video and a frame rate of the aerial video.

11. The system of claim 1, wherein the processing circuitry is further configured to:
execute, via the processing circuitry, a pinhole camera model with no distortion;
execute, via the processing circuitry, a flat ground model; and
obtain as the source input, the aerial video of the traffic scene including the vehicles that traverse the traffic scene from the pinhole camera model and the flat ground model.

12. The system of claim 1, wherein the processing circuitry is further configured to:
execute, via the processing circuitry, a vehicle model fitting algorithm to identify specific vehicle models
aggregate, via the vehicle model fitting algorithm, collection of publicly available 3D vehicle models;
pre-process the aggregated publicly available 3D vehicle models to generate a set of candidate vehicle models having a 1:1 scale corresponding to real-world vehicles; and
track the vehicles that traverse the traffic scene across the individual frames of the aerial video utilizing the candidate vehicle models.

13. The system of claim 12, wherein the processing circuitry is further configured to:
pre-process the aggregated publicly available 3D vehicle models to generate a set of candidate vehicle models by:
concatenating (x, y, z) coordinates of all of the multiple unique keypoints on the vehicles that traverse the traffic scene onto the set of candidate vehicle models as a shape vector {Sᵢ} when corresponding coordinates are available for each respective vehicle within the set of candidate vehicle models.

14. The system of claim 13, wherein the processing circuitry is further configured to:
create bounding boxes within the calibrated images of the traffic scene encompassing each of the vehicles utilizing the multiple unique keypoints determined for each of the respective vehicles;
execute, via processing circuitry, Principal Component Analysis (PCA) on each of the candidate vehicle models as the shape vector {Sᵢ} for all candidate vehicle models to determine mean shape sₘ for each of the candidate vehicle models; and
for each respective one of the vehicles that traverse the traffic scene, identify a best fit among the candidate vehicle models based on a comparison of the multiple unique keypoints and the bounding boxes created within the calibrated images using the shape vector {Sᵢ} and the mean shape sₘ determined for each of the candidate vehicle models.

15. The system of claim 1, wherein the processing circuitry is further configured to:
determine each of the multiple unique keypoints on the vehicles that traverse the traffic scene based on an identifiable vehicle keypoint of each respective one of the vehicles that traverse the traffic scene, wherein each identifiable vehicle keypoint is selected from the group comprising:
corner of a vehicle roof top;
corner of a vehicle front windshield;
corner of a vehicle rear window;
center of a vehicle front light;
center of a vehicle rear light;
center of a vehicle front bumper;
center of a vehicle rear bumper;
center of a vehicle wheel;
corner of a vehicle chassis bottom surface;
outermost corner of a vehicle side mirror;
corner of a vehicle front door window;
wheel-to-ground contact point of a vehicle; and
center of a vehicle front brand logo.

16. The system of claim 1, wherein the processing circuitry is further configured to:
subsequent to output of the vehicle metrics for one or more of the vehicles that traverse the traffic scene, output, via the processing circuitry and for display, a simulation of one or more of the vehicles that traverse the traffic scene;
receive as input, modifications to physical properties of the one or more of the vehicles that traverse the traffic scene within the simulation; and
responsive to receipt of the input, the modifications to the physical properties of the one or more of the vehicles that traverse the traffic scene within the simulation, output, via the processing circuitry and for display, a re-simulation of the one or more of the vehicles that traverse the traffic scene using the modifications to the physical properties of the one or more of the vehicles received as input.

17. A computer-implemented method comprising:
obtaining as source input, aerial video of a traffic scene including vehicles that traverse the traffic scene;
obtaining a satellite map image of the traffic scene distinct from any aerial image of the traffic scene within the source input;
determining aerial image reference points of the traffic scene present within the source input which correspond to satellite map image reference points of the traffic scene present within the satellite map image of the traffic scene;
responsive to determining the aerial image reference points of the traffic scene present within the source input which correspond to satellite map image reference points of the traffic scene present within the satellite map image of the traffic scene, generating calibrated images of the traffic scene from individual frames of the aerial video of the traffic scene by calibrating the individual frames of the aerial video with the satellite map image of the traffic scene utilizing the corresponding satellite map image reference points of the traffic scene;
determining multiple unique keypoints on the vehicles that traverse the traffic scene;
responsive to determining the multiple unique keypoints on the vehicles that traverse the traffic scene, tracking the vehicles that traverse the traffic scene across the individual frames of the aerial video utilizing the multiple unique keypoints determined on the vehicles; and
outputting vehicle metrics for one or more of the vehicles that traverse the traffic scene.

18. The computer-implemented method of claim 17, further comprising:
executing a CAR-OnMap (“CAROM”) air framework for vehicle localization and traffic scene reconstruction using the aerial video of the traffic scene.

19. Computer-readable storage media comprising instructions that, when executed, configure processing circuitry to:
obtain as source input, aerial video of a traffic scene including vehicles that traverse the traffic scene;
obtain a satellite map image of the traffic scene distinct from any aerial image of the traffic scene within the source input;
determine aerial image reference points of the traffic scene present within the source input which correspond to satellite map image reference points of the traffic scene present within the satellite map image of the traffic scene;
responsive to determination of the aerial image reference points of the traffic scene present within the source input which correspond to satellite map image reference points of the traffic scene present within the satellite map image of the traffic scene, generate calibrated images of the traffic scene from individual frames of the aerial video of the traffic scene by calibrating the individual frames of the aerial video with the satellite map image of the traffic scene utilizing the corresponding satellite map image reference points of the traffic scene;
determine multiple unique keypoints on the vehicles that traverse the traffic scene;
responsive to the determination of the multiple unique keypoints on the vehicles that traverse the traffic scene, track the vehicles that traverse the traffic scene across the individual frames of the aerial video utilizing the multiple unique keypoints determined on the vehicles; and
output vehicle metrics for one or more of the vehicles that traverse the traffic scene.

20. The computer-readable storage media comprising of claim 19, wherein the processing circuitry is further configured to:
execute, via the processing circuitry, a CAR-OnMap (“CAROM”) air framework for vehicle localization and traffic scene reconstruction using the aerial video of the traffic scene.
